(19) United States
(12) Patent Application Publication
(10) Pub. No.: US 2025/0216523 A1
(43) Pub. Date: Jul. 3, 2025

(54) TIME-OF-FLIGHT SENSOR CALIBRATION SYSTEM

(71) Applicant: GM Cruise Holdings LLC, San Francisco, CA (US)

(72) Inventors: Zhanping Xu, Sunnyvale, CA (US); Mateusz Monterial, Livermore, CA (US); Srinivasa Cheekati, San Francisco, CA (US); Ralph Spickermann, Redwood City, CA (US)

(21) Appl. No.: 18/402,472

(22) Filed: Jan. 2, 2024

(51) Int. Cl. G01S 7/497; G01S 7/481

(52) U.S. Cl. CPC G01S 7/497; G01S 7/4818

(57) ABSTRACT

Systems and techniques are provided for calibrating time-of-flight (TOF) sensors. An example method can include sending, from a TOF sensor system coupled to a calibration assembly, a light signal to a fiber optic cable coupled to the calibration assembly; receiving, by the calibration assembly, the light signal from the fiber optic cable; diffusing the light signal via one or more diffusers on the calibration assembly; generating, by the TOF sensor system, one or more measurements based on the diffused light signal; and based on the one or more measurements, determining one or more calibration values configured to compensate for one or more errors in the one or more measurements.

### TECHNICAL FIELD

The present disclosure generally relates to time-of-flight (TOF) sensors and, more specifically, calibration of TOF sensors.

### BACKGROUND

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users and systems to obtain sensor data that measures, describes, and/or depicts one or more aspects of a target such as an object, a scene, a person, and/or any other targets. For example, a time-of-flight (TOF) sensor can be used to measure distance to one or more objects in an environment. However, the performance and/or accuracy of certain sensors, such as TOF sensors, can be affected by one or more factors such as, for example, environmental factors (e.g., temperature, ambient light, etc.) and sensor configurations, among others.

### BRIEF DESCRIPTION OF THE DRAWINGS

Illustrative examples and aspects of the present application are described in detail below with reference to the following figures:

FIG. 1 is a diagram illustrating an example system environment that can be used to facilitate autonomous vehicle (AV) navigation and routing operations, according to some examples of the present disclosure;

FIG. 2 is a block diagram illustrating an example of an electronic device that can be used to capture sensor data, according to some examples of the present disclosure;

FIG. 3 is a block diagram illustrating an example environment with a time-of-flight sensor, according to some examples of the present disclosure;

FIG. 4 is a diagram illustrating an example calibration system with an enclosure used to calibrate a time-of-flight sensor, according to some examples of the present disclosure;

FIG. 5 is a diagram illustrating an example calibration system with a defined optical path for calibrating a time-of-flight sensor, according to some examples of the present disclosure;

FIG. 6 is a diagram illustrating another example calibration system for calibrating a time-of-flight sensor, according to some examples of the present disclosure;

FIG. 7 is a diagram illustrating another example calibration system for calibrating a time-of-flight sensor, according to some examples of the present disclosure;

FIG. 8 is a diagram illustrating another example calibration system for calibrating a time-of-flight sensor, according to some examples of the present disclosure;

FIG. 9 is a flowchart illustrating an example process for calibrating a time-of-flight sensor, according to some examples of the present disclosure; and

FIG. 10 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of the subject matter of the application. However, it will be apparent that various aspects and examples of the disclosure may be practiced without these specific details. The figures and description are not intended to be restrictive.

The ensuing description provides examples and aspects of the disclosure, and is not intended to limit the scope, applicability, or configuration of the disclosure. Rather, the ensuing description of the examples and aspects of the disclosure will provide those skilled in the art with an enabling description for implementing an example implementation of the disclosure. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. For example, an autonomous vehicle (AV) (also known as a self-driving car, driverless vehicle, and robotic vehicle) can use various sensors to sense and navigate an environment without human input. The sensors can collect sensor data that measures, describes, and/or depicts one or more aspects of a scene and/or a target such as an object, a scene, a person, and/or any other targets. To illustrate, in some cases, an AV can use a time-of-flight (TOF) sensor to measure distance to one or more objects in an environment, detect an object in the environment, and/or track an object in the environment.

In some examples, to generate distance measurements, a TOF sensor can emit a pulse of light and measure the time it takes for the light to reflect from a target. In some cases, to generate distance measurements, the TOF sensor can measure phase delays in the reflected light as a proxy for determining the time delay of the light reflected from the target. Generally, the accuracy of TOF sensors can be affected by one or more factors such as, for example and without limitation, environmental factors (e.g., temperature, humidity, ambient light, etc.), time and phase delays, calibration parameters, inhomogeneities (e.g., signal inhomogeneities, pixel measurement inhomogeneities, sensor chip/silicon inhomogeneities, phase inhomogeneities, etc.), optical path uncertainties, crosstalk/coupling, and/or sensor configurations, among others. For example, the light signal measured by the TOF sensor can have phase delays (and time delays) that negatively affect the accuracy and reliability of the TOF sensor measurements. The phase delays (and time delays) can be caused by a number of factors such as, for example, temperature conditions (e.g., thermal effects) on/along the light transmission and/or receiving channel of the TOF sensor, signal distribution inhomogeneities (e.g., pixel-to-pixel delays, offsets, variations, etc.), resistor-capacitor (RC) effects (e.g., RC propagation delays) caused by operating temperatures and circuit resistance/capacitance, and/or system/circuit inhomogeneities, among others.

To improve the accuracy and reliability of TOF sensor measurements, the TOF sensor can be calibrated to apply one or more compensation/calibration offsets in order to account and/or compensate for any factors that can impact the accuracy of the TOF sensor measurements such as, for example, delays (e.g., phase delays, time delays, etc.) caused by the temperature conditions (e.g., thermal effects) on/along the light transmission and/or receiving channel of the TOF sensor, the signal distribution inhomogeneities (e.g., pixel-to-pixel delays, offsets, variations, etc.), the RC effects (e.g., RC propagation delays), the system/circuit inhomogeneities, etc. However, the delays and associated conditions/factors can be difficult to accurately control and/or estimate in order to accurately calibrate the TOF sensor. Moreover, the calibration process can be further affected by other factors that may also be difficult to accurately control and/or estimate. For example, the light emitted and received by the TOF sensor can take multiple paths, which can result in signal distortions caused by crosstalk (e.g., signal coupling) and calibration uncertainties associated with undefined optical paths. If such light paths are not accurately controlled and/or known/defined, it can be difficult to accurately manage and/or account/compensate for associated errors/inaccuracies, which can further impact the accuracy of the TOF sensor calibration. Also, the multiple paths can result in undefined paths for the light, which can cause calibration errors/problems.

Systems, apparatuses, processes (also referred to as methods), and computer-readable media (collectively referred to as “systems and techniques”) are described herein for calibrating TOF sensors. In some aspects, the systems and processes described herein can be used to implement a calibration system that uses a fiber optic cable as a defined and controlled path for the light signals generated by a TOF sensor and used to calibrate one or more offsets for the TOF sensor. The calibration system can isolate the light signals from the external environment to prevent distortions caused by external/stray light (e.g., ambient light), external environment conditions, light reflections and multiple corresponding light paths (e.g., undefined paths), etc. Moreover, the calibration system can implement one or more diffusers used to diffuse the light to generate homogenized light with a homogenized phase front, which can help offset pixel-to-pixel variations, laser speckle pattern effects, etc.

The one or more diffusers can also help and/or enable calibration with a calibration system that includes a lens (e.g., though the one or more diffusers can be implemented in a TOF sensor calibration system that includes or does not include a lens), such as a fully assembled calibration system with a lens, as the lens could otherwise be problematic since it maps observed light in the real world to specific pixels and, thus, without the one or more diffusers, the calibration system may otherwise measure the inhomogeneity in the incoming phase front of the observed light. Therefore, the use of the one or more diffusers according to the systems and techniques described herein can advantageously allow the TOF sensor to be calibrated even after the TOF sensor is fully assembled and ensure that the calibration accounts for the variations and causes of delays among the various components of the TOF sensor, thus allowing repeated calibrations even after the TOF sensor has been fully assembled, rather than just once in the factory (e.g., prior to full assembly of the TOF sensor).

For example, the one or more diffusers can distribute the light onto the TOF sensor chip, with an equal or quasi equal phase front that can be used for systematic calibration. By equalizing the phase front of the light, the systems and techniques described herein can calibrate (and/or more accurately calibrate) each pixel of a depth map generated by the TOF sensor. For example, in some cases, each pixel (or multiple pixels) captured by a TOF sensor can have a different offset associated with pixel-to-pixel variations. To calibrate the different offsets (e.g., to calibrate each pixel), the systems and techniques described herein can apply a scaler to the different offsets. The equalized phase front of the light can be used as the scaler used for such calibration of the different offsets. In some examples, the diffused light can help prevent or reduce/minimize input phase inhomogeneities (e.g., input equalization) as the pixels on the array can receive the light with superimposed and diffused wave fronts.

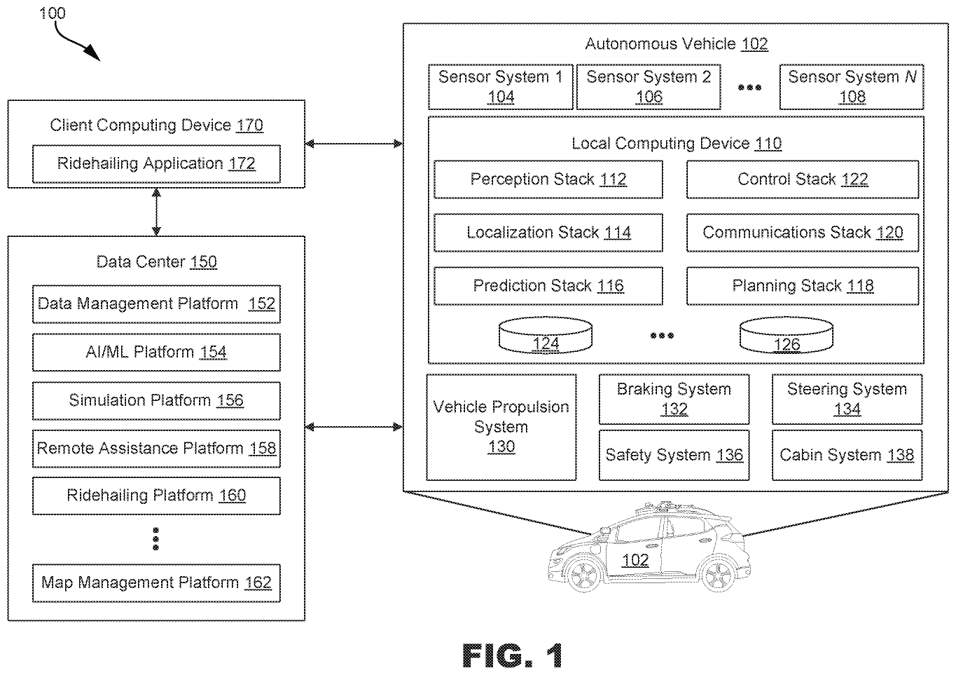

The systems and techniques described herein can be used to calibrate one or more TOF sensors used for any use case or application such as, for example and without limitation, an autonomous vehicle application, a robotic system application, an unmanned aerial vehicle application, a virtual/extended/augmented reality system application, a tool, a manufacturing application, a sensor system application, and/or any other use case or application. For illustration and explanation purposes, the systems and techniques described herein are discussed with respect to calibrating a TOF sensor that can be implemented in an autonomous vehicle environment, such as autonomous vehicle environment 100 shown in FIG. 1.

Various examples of the systems and techniques described herein are illustrated in FIG. 1 through FIG. 10 and described below.

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridesharing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. In some cases, the client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs (e.g., AV 102), Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehailing application 172 to enable passengers to view the AV 102 in transit to a pick-up or drop-off location, and so on.

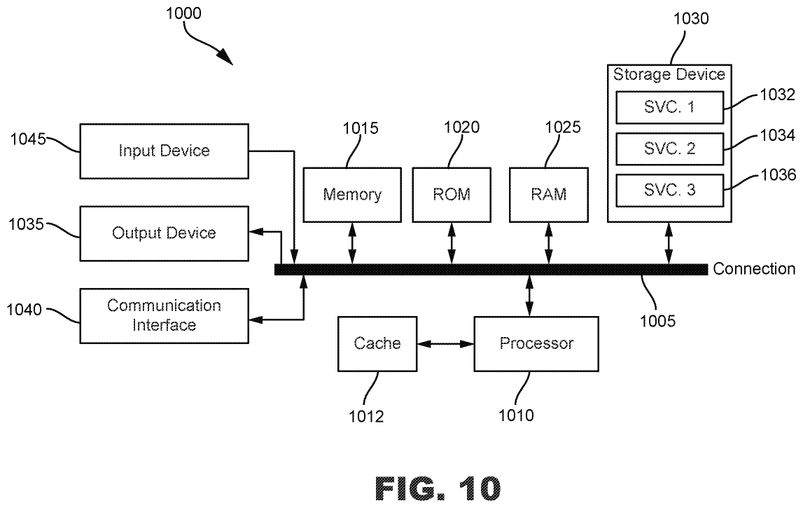

While the AV 102, the local computing device 110, and the AV environment 100 are shown to include certain systems and components, one of ordinary skill will appreciate that the AV 102, the local computing device 110, and/or the AV environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 10.

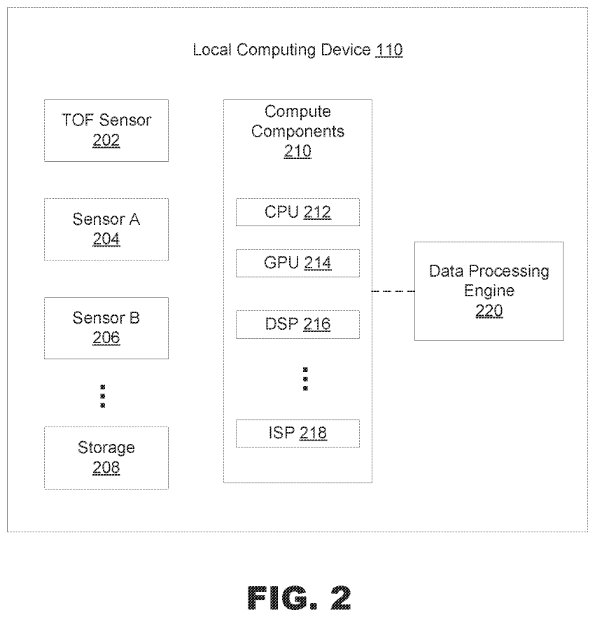

FIG. 2 is a diagram illustrating an example electronic device used to capture sensor data. The electronic device can include or represent a computing device, such as the local computing device 110 shown in FIG. 1. In other examples, the electronic device can include or represent any other device used to capture and process sensor data as further described herein.

In some examples, the local computing device 110 can be configured to perform three-dimensional (3D) image signal processing. In some aspects, the local computing device 110 can be configured to provide one or more functionalities such as, for example, imaging functionalities, image processing functionalities, 3D image filtering functionalities, image data segmentation functionalities, depth estimation functionalities, phase unwrapping functionalities, AV perception and/or detection functionalities (e.g., object detection, pose detection, face detection, shape detection, scene detection, etc.), localization functionalities, tracking functionalities, system management and/or control functionalities, autonomous driving functionalities, sensor calibration functionalities, computer vision functionalities, robotic functions, sensor fusion, sensor data processing, automation, and/or any other computing functionalities.

In the illustrative example shown in FIG. 2, the local computing device 110 can include a time-of-flight (TOF) sensor 202 (also referred to as TOF camera) and one or more sensors such as sensor 204 and sensor 206, which can be the same as or similar to any of the sensor systems 104-108 illustrated in FIG. 1. In some examples, the TOF sensor 202 can be a 3D TOF camera system configured to create a 3D image of a scene or object (e.g., a 3D point cloud or depth map). Non-limiting examples of the one or more sensors (e.g., sensor 204 and/or sensor 206) can include a camera, an ultrasonic sensor, an IMU, a depth sensor using any suitable technology for determining depth (e.g., based on TOF, structured light, or other depth sensing technique or system), a touch sensor, a LIDAR sensor, a RADAR sensor, a microphone, etc.

In some examples, the TOF sensor 202 and/or the one or more sensors (e.g., sensor 204 and/or sensor 206) can capture image data and generate frames based on the image data and/or provide the image data or frames to one or more compute components 210 for processing. A frame can include a video frame of a video sequence or a still image.

In the illustrative example of FIG. 2, the local computing device 110 can include a storage 208 and the one or more compute components 210. The storage 208 can include any storage device(s) for storing data such as, for example and without limitation, image data, configuration data, scene data, user data, system data, measurements, preferences, software data, parameters, sensor data, processed data, input data, output data, calculations, etc. In some examples, the storage 208 can store data from any of the components of the local computing device 110. For example, the storage 208 can store data or measurements from the TOF sensor 202, the one or more sensors (e.g., sensor 204, sensor 206, etc.), the compute components 210 (e.g., processing parameters, outputs, video, images, segmentation maps/masks, depth maps, filtering results, confidence maps, masks, calculation results, detection results, etc.), the data processing engine 220, and/or any other components. In some examples, the storage 208 can include a buffer for storing data for processing by compute components 210.

In some cases, the local computing device 110 can include one or more compute components 210 such as a central processing unit (CPU) 212, a graphics processing unit (GPU) 214, a digital signal processor (DSP) 216, an image signal processor (ISP) 218, etc. In some aspects, the local computing device 110 can use the one or more compute components 210 to perform various computing operations such as, for example, image processing functionalities, precision predictions of sensor data as described herein, autonomous driving operations, localization operations, classification, pose estimation, mapping, detection (e.g., face detection, object detection, scene detection, human detection, etc.), image segmentation, system control operations, image/video processing, graphics rendering, machine learning, data processing, modeling, calculations, computer vision, sensor fusion, sensor data processing, sensor calibration operations, and/or any other operations.

In some cases, the one or more compute components 210 can perform image/video processing, machine learning, depth estimation, sensor data processing, sensor calibration, system management/control, detection (e.g., object detection, face detection, scene detection, human detection, etc.), and/or other operations as described herein using data from the TOF sensor 202, the one or more sensors (e.g., sensor 204, sensor 206, etc.), the storage 208, and/or any other sensors and/or components. In some examples, the one or more compute components 210 can implement one or more software engines and/or algorithms such as, for example, data processing engine 220 or any algorithm as described herein. In some cases, the one or more compute components 210 can implement one or more other or additional components and/or algorithms that are not illustrated in FIG. 2, such as a machine learning model(s), a computer vision algorithm(s), a neural network(s), and/or any other algorithm and/or component that is/are not shown in FIG. 2.

In some aspects, the data processing engine 220 can implement one or more algorithms and/or machine learning models configured to generate depth estimates, generate depth standard deviations, perform image processing, perform sensor calibration, process TOF sensor data, etc., as further described herein. In some examples, the data processing engine 220 can be configured to calibrate the TOF sensor 202 as described herein.

In some aspects, the local computing device 110 can be part of, or implemented by, a single computing device or multiple computing devices. In some examples, the local computing device 110 can be part of and/or include an electronic device (or devices) such as a computer system (e.g., a server, a laptop computer, a tablet computer, etc.), a camera system (e.g., a digital camera, an IP camera, a video camera, a security camera, etc.), a telephone system (e.g., a smartphone, a cellular telephone, a conferencing system, etc.), a display device, a mobile device, an IoT (Internet-of-Things) device, or any other suitable electronic device(s).

The components shown in FIG. 2 with respect to the local computing device 110 are illustrative examples provided for explanation purposes. In other examples, the local computing device 110 can include more or less components than those shown in FIG. 2. While the local computing device 110 is shown to include certain components, one of ordinary skill will appreciate that the local computing device 110 can include other components than those shown in FIG. 2. For example, the local computing device 110 can include, in some instances, one or more memory devices (e.g., RAM, ROM, cache, and/or the like), one or more networking interfaces (e.g., wired and/or wireless communications interfaces and the like), one or more display devices, one or more caches, and/or any other hardware or processing devices that are not shown in FIG. 2. An illustrative example of a computing device and/or hardware components that can be implemented with the local computing device 110 are described below with respect to FIG. 10.

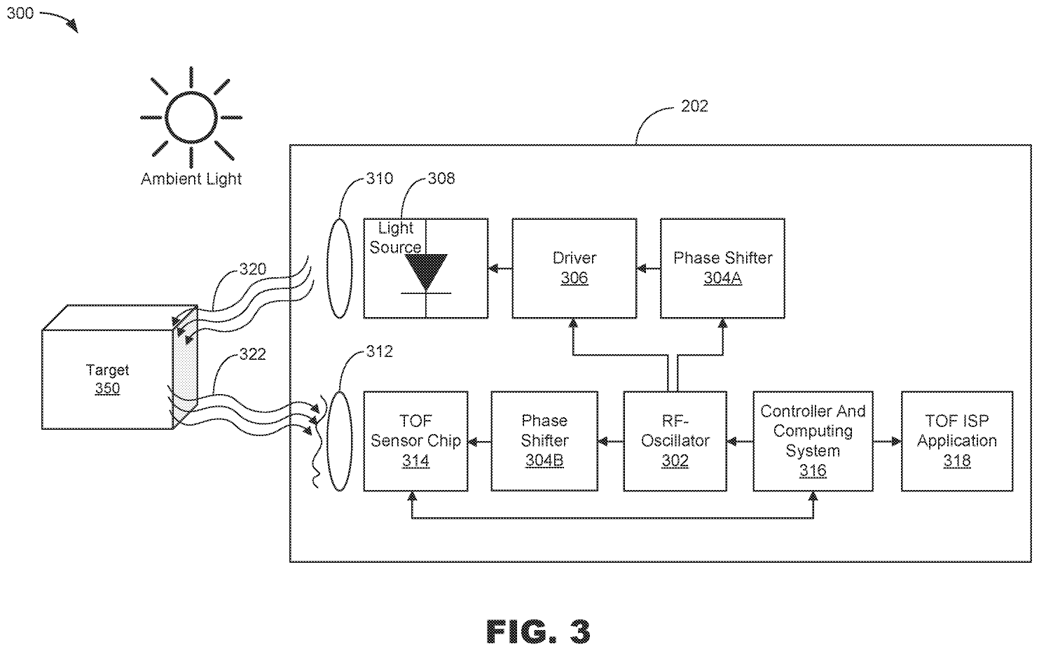

FIG. 3 illustrates an example environment 300 with a TOF system. In this example, the TOF system is TOF sensor 202 described above with respect to FIG. 2. The TOF sensor 202 can be used to implement the systems and techniques described herein. For example, the TOF sensor 202 can include a range imaging camera system that resolves distance based on the speed of light, a measured time-of-flight of a light signal between the camera and target in the scene for each point of a captured frame, and can be calibrated according to the systems and techniques described herein.

As explained previously, the TOF sensor 202 can work by illuminating a scene with a transmitted light 320 (e.g., transmitted signal, modulated output/signal, pulsed light, incident light, or emitted light/signal) and observing (e.g., receiving, capturing or recording, sensing, measuring, analyzing, detecting via homodyne detection, etc.) a received light 322 (e.g., received signal, backscattered light/signal, or reflected signal/light) that is backscattered (e.g., reflected) by a target 350. In the illustrative example of FIG. 3, the TOF sensor 202 can include a local oscillator clock 302 (e.g., radio frequency (RF) oscillator), a phase shifter 304A at a transmission channel, a phase shifter 304B, a driver 306, a light source 308, a transmit optical system 310, a receiving optical system 312, and a controller and computing system 316 supporting an application 318.

In some cases, the local oscillator clock 302 can include any applicable type of oscillator clock, otherwise referred to as a radio frequency (RF)-oscillator clock. The local oscillator clock 302 can generate a clock signal that can be used to modulate an output signal of the TOF sensor 202 (e.g., transmitted light 320) and/or to demodulate the TOF pixels on the sensor array (TOF sensor chip 314). In some aspects, the phase shifter 304B in the receiving channel and a driver 306 in the transmitting channel (and/or optionally the phase shifter 304A in the transmitting channel) can receive the clock signal generated by the local oscillator clock 302 and delay it for purposes of creating phase adjusted offsets. In some examples, the phase shifter 304A can be implemented on the transmitting channel and the phase shifter 304B can be implemented on the receiving channel to affect modulation of the signal generated by a light source 308. In some examples, the phase shifter 304B can be implemented between the TOF sensor chip 314 and the local oscillator clock 302 or directly integrated with the TOF sensor chip 314.

In some examples, the driver 306 in the transmitting channel can receive the phase adjusted clock signal from the phase shifter 304A and modulate the signal based on the phase adjusted clock signal to generate a modulated output (e.g., transmitted light 320) from the light source 308. In some examples, the illumination of the TOF sensor 202 can be generated by the light source 308. The light source 308 can include, for example and without limitation, a solid-state laser (e.g., a laser diode (LD), a vertical-cavity surface-emitting laser (VCSEL), etc.), a light-emitting diode (LED), etc.), a lamp, and/or any other light emitter or light emitting device.

In some aspects, the transmitted light 320 (e.g., modulated output from the light source 308) can pass through the transmit optical system 310 and be transmitted towards the target 350 in a scene. The transmitted light 320 can be shaped by the transmit optical system 310 before being transmitted towards the target 350. In some cases, the target 350 can include any type of target, surface, interface, and/or object such as, for example and without limitation, a human, an animal, a vehicle, a tree, a structure (e.g., a building, a wall, a shelter such as a bus stop shelter, etc.), an object, a surface, a device, a material with a refractive index that allows at least some light (e.g., transmitted light 320, ambient light, etc.) to be reflected/backscattered from the material, and/or any other target, surface, interface, and/or object in a scene.

As previously noted, in the illustrative example of FIG. 3, the TOF sensor 202 can include a receiving optical system 312, a TOF sensor chip 314, and a controller and computing system 316 supporting an application 318. In the example environment 300, when the transmitted light 320 (e.g., an RF modulated infrared (IR) optical signal with an equal wave front) interacts with the target 350, at least some of the transmitted light 320 can be reflected back towards the TOF sensor 202 as a received light 322 (e.g., backscattered signal, light incident on the TOF sensor 202, etc.).

In some examples, the received light 322 passes through the receiving optical system 312 to the TOF sensor chip 314. The received light 322 can include the RF modulated IR optical signal backscattered with different time-of-flight delays. The different TOF delays in the received light 322 can represent, include, or otherwise encode 3D information of the target 350. As used herein, 3D information of a target can include applicable information defining characteristics of a target in 3D space. For example, 3D information of a target can include range information that describes a distance between a reference and the target or a portion of the target.

In some examples, the light that is received by and/or enters (e.g., the light incident on) the receiving optical system 312 and/or the TOF sensor chip 314 can include a reflected component. In other examples, the light that is received by and/or enters (e.g., the light incident on) the receiving optical system 312 and/or the TOF sensor chip 314 can include a reflected component as well as an ambient component. In some examples, the distance (e.g., depth) information may be embedded in, measured from, and/or defined by the reflected component or may only be embedded in the reflected component. As such, a certain amount of (and/or any amount of) an ambient component can reduce the signal-to-noise ratio (SNR).

In some examples, TOF depth image processing methods can include collecting correlation samples (CSs) to calculate a phase estimate. For example, correlation samples of a TOF pixel and/or image can be collected at one or more time points, such as sequential time points, and at different phase shift/offset conditions. The signal strength of the correlation samples varies with the different phase shifts. As such, the samples output from the TOF pixel and/or image can have different values.

In some cases, the TOF sensor chip 314 can detect varying TOF delays in the received light 322. As follows, the TOF sensor chip 314 can communicate with the controller and computing system 316 to process the TOF delays and generate 3D information based on the TOF delays.

In some aspects, the controller and computing system 316 can support an application 318 that performs further signal processing and control various functional aspects, for example, based on the 3D information. For example, the application 318 can control or facilitate control of an AV (e.g., AV 102 as illustrated in FIG. 1) based on the 3D information.

As explained, the light from a modulated light source (e.g., transmitted light 320) is backscattered by the target 350 in the field of view of the TOF sensor 202, and the phase shift between the transmitted light 320 and the received light 322 can be measured. By measuring the phase shift at a modulation frequency (or multiple modulation frequencies), a depth value for each pixel can be calculated. In one illustrative example, based on a continuous-wave (CW) method, the TOF sensor 202 can take multiple samples per measurement, e.g., with each sample phase-stepped by, e.g., 90 degrees, for a total of four samples (however, the present technology is not limited to a 4 phased-stepped implementation). Using this technique, the TOF sensor 202 can calculate the phase angle between illumination and reflection and the distance associated with the target 350. In some cases, a reflected amplitude (A) and an offset (B) can have an impact on the depth measurement precision or accuracy. Moreover, the TOF sensor 202 can approximate the depth measurement variance. In some cases, the reflected amplitude (A) can be a function of the optical power, and the offset (B) can be a function of the ambient light and residual system offset. In some examples, the offset (B) can include one or more calibration/compensation offsets as further described herein.

When the received light 322 arrives at a TOF sensor of the TOF sensor 202 (e.g., through a lens of the TOF sensor 202), each pixel of the TOF sensor demodulates the received light 322 (e.g., modulated light) generated by electrons and concurrently integrates the photogenerated charges in pixel capacitors at multiple phase shift steps or phase offsets at multiple phase windows. In this way, the TOF sensor 202 can acquire a set of raw TOF data. The TOF sensor 202 can process the raw TOF data. For example, the TOF sensor 202 can demodulate the time-of-flight and use the time-of-flight to calculate the distance from the TOF sensor 202 to the target 350. In some cases, the TOF sensor 202 can also generate an amplitude image of active light (A) and a grayscale image of passive light or offset part (B) of the active light.

In some examples, the distance demodulation can establish the basis for estimating depth by the TOF sensor 202. In some aspects, each pixel of the TOF sensor 202 can demodulate the received light 322 to extract information encoded as modulation of the phase of the received light 322 by comparing or matching the received light 322 to the transmitted light 320 (e.g., homodyne demodulation). In some cases, the TOF sensor 202 can implement a single-tap pixel architecture or a multi-tap pixel architecture. In some cases, the pixel design of the TOF sensor 202 can store charge in two different gates, which can oscillate back and forth at the same frequency as the transmitted light 320 (e.g., akin to a 180-degree phase shift). For example, in some cases, there can be multiple capacitors and multiple integral windows with a phase difference π under each pixel of the TOF sensor 202. In one sampling period, the pixel can be designed with electronics and capacitors that can process and accumulate the differential charge or samples. This process is called differential correlation sampling (DCS), and may be used as a method to cancel or minimize the offset (B) from the correlation results. In an example implementation of a 4-DCS method, the capacitors can sample a signal four times at four phases such as 0°, 90°, 180° and 270° phases. The TOF sensor 202 can use the sample results (e.g., DCS1, DCS2, DCS3, DCS4 sampled at different phase shifts between the transmitted light 320 and the received light 322 to calculate the distance of the target 350 (relative to the TOF sensor 202) based on the phase shift.

In some examples, the TOF sensor 202 can measure a distance for every pixel to generate a depth map. In some cases, a depth map can include a collection of points (e.g., each point is also known as a voxel). In some cases, the depth map can be rendered in a two-dimensional (2D) representation or image. In other cases, a depth map can be rendered in a 3D space as a collection of points or point cloud. In some examples, the 3D points can be mathematically connected to form a mesh onto which a texture surface can be mapped.

In some aspects, a TOF sensor (e.g., TOF sensor 202) can be calibrated to compensate for various errors and/or error sources that can cause inaccurate measurements. Non-limiting examples of error sources that can affect the measurements of a TOF sensor can include distance response non-uniformity (DRNU) of the TOF sensor, temperature drift, ambient light, the magnitude of the signal, resistance-capacitance (RC) effects, flat-field errors of the pixel field, column A/D converter differences, row addressing differences, fix-pattern noise caused by manufacturing intolerances, laser speckle patterns, pixel depth differences, etc. For example, the measurements of a TOF sensor can be negatively affected by the accumulated signal phase delays along the transmit and receive channels, which can be caused by different factors as described herein. In some examples, the pixels in the depth map generated by the TOF sensor can have different values/measurements, which can create inaccuracies. The different values associated with the pixels can be caused by respective phase delays associated with the pixels. For example, each pixel can have its own phase delay due to, for example, the TOF sensor silicon inhomogeneity, RC propagation and buffer inhomogeneity, thermal effects within the TOF sensor, pixel driver architecture/distribution, etc. In some cases, the phase delays resulting from TOF sensor silicon inhomogeneities, RC propagation and buffer inhomogeneities, thermal effects, pixel driver architecture/distribution, etc., can be corrected or mitigated using an equalized/homogenized phase front on the array for calibration, as further described herein.

In general, the TOF sensor 202 can work at a thermal non-equilibrium status, which may cause different time delays at the corresponding temperature conditions, denoted with different temperature T index, e.g., Tₙ (n=1, 2, . . . ). Equation (1) below illustrates an example of an accumulated phase delay of a TOF sensor:

$${Δ}_{{φ}_{TR}} = 2 π f ( {t}_{osc 1} ( {T}_{1} ) + {t}_{D L L} ( {T}_{2} ) + {t}_{D r} ( {T}_{3 x} ) + {t}_{V C S E L} ( {T}_{4 x} ) ) - 2 π f ( {t}_{osc 2} ( {T}_{1} ) + {t}_{sft} ( {T}_{5} ) + {t}_{p i x} ( {T}_{6 x} , i , j ) ) \qquad Equation ( 1 )$$

where Δ_{φTR} represents the differential of the accumulated phase delays along the sending channel (Tx) and the accumulated phase delays along the receiving channel (Rx), T₁ represents temperature, t_{osc1} represents an oscillator bus line (to the transmitting (Tx) channel) time delay (e.g., from RF-oscillator 302), t_{DLL} represents a phase shifter time delay (e.g., phase shifter 304A which can be or include an analog device designed at the Tx channel) associated with the phase shifter 304A, t_{Dr} represents a driver time delay (e.g., driver 306), t_{VCSEL} represents a light source time delay (e.g., light source 308), t_{sft} (T₅) represents the phase shifter delay on the receiving channel (e.g., phase shifter 304B), and tₚᵢₓ represents a pixel time delay for pixel (i,j). Moreover, in Equation (1) above, 2πf(t_{osc1}(T₁)+t_{DLL}(T₂)+t_{Dr}(T₃ₓ)+T_{VCSEL}(T₄ₓ)) represents the accumulated phase delays along the transmitting channel, and 2πf(t_{osc2}(T₁)+t_{sft}(T₅)+tₚᵢₓ(T₆ₓ), i, j)) represents the accumulated phase delays along the receiving channel.

In some examples, the accumulated phase delays in Equation (1) can be approximated as follows:

$${Δ}_{{φ}_{TR}} = 2 π f Δ {t}_{s y s} + 2 π f ( {t}_{V C S E L d r} ( {T}_{4 x} ) - {t}_{p i x} ( {T}_{6 x} , i , j ) ) \qquad Equation ( 2 )$$

In some examples, Equation (2) can be rewritten as:

$${Δ}_{{φ}_{T R}} \approx 2 π f Δ {t}_{s y s} + 2 π f ( {t}_{V C S E L d r} ( {T}_{3} ) - {t}_{p i x} ( {T}_{5} , i , j ) ) \qquad Equation ( 3 )$$

where i, j represents the pixel index, t_{sys} represents a design related systematic time delay (e.g., an approximation of the overall/accumulated delays intrinsic to the system, including any time delays related to clock signals and bus lines with different electrical paths), T₅ represents the chip temperature (e.g., TOF sensor chip 314), and T₃ represents the light source temperature (e.g., VCSEL 308) as well as the drivers. The environmental temperature (which may or may not be measured) can be a factor that may become another dependent variable in the temperature compensation model and may be used as an additional input to one or more of the t functions defined herein, such as tₚᵢₓ, etc.

In some examples, a TOF measurement can be obtained and used to get a pixel-wise global offset. If the external environment path (OF0) is homogenized with a diffuser(s) as described herein, the accumulated delays (e.g., including the accumulated delays intrinsic to the system) can be calculated using Equation (4) as follows:

$${Δ}_{{φ}_{TR}} \approx Of 0 + 2 π f Δ {t}_{s y s} + 2 π f ( {t}_{V C S E L d r} ( {T}_{3} ) - {t}_{p i x} ( {T}_{5} , i , j ) ) \qquad Equation ( 4 )$$

In Equation (4), OF0 can represent the external environment path associated with the calibration system, e.g., the optical fiber, etc. In some examples, after the TOF measurement, the constant OF0 from Equation (4) can be adjusted to represent the external environment path and pixel-to-pixel variations. In some cases, if a mapping-based global measurement without a diffuser(s) is used, the term OF1, defined below, can become OF1 (i,j), and/or can include a variable radian distance and spatial-based path(s). In some examples, the accumulated delays in the system can be calculated according to Equation (5) below:

$${Δ}_{{φ}_{T R}} \approx OF 1 ( i , j ) + 2 π f Δ {t}_{s y s} + 2 π f ( {t}_{V C S E L d r} ( {T}_{3} ) - {t}_{p i x} ( {T}_{5} , i , j ) ) \qquad Equation ( 5 )$$

In Equation (5) above, the term OF1 can represent the pixel-to-pixel variations and the external environment path from OF0. In some examples, the model can include and/or account for a pixel global offset, which can depend on an operational frequency and temperature. In some cases, the calibration system can sweep temperatures and characterize the temperature response of the model. In other cases, rather than sweeping frequencies, which can be intrinsic operational parameters, the TOF sensor can be calibrated on the known frequencies that will be used for operation.

In some aspects, the TOF sensor calibration can include obtaining a calibration phase map on the array of the TOF sensor and temperature readings from one or more sensors (e.g., a temperature sensor), a temperature sensor of the light source (e.g., light source 308), and/or a thermal sensor associated with the TOF sensor. The calibration can then process the relation of the signal phase distribution versus the array location and temperature effects, and abstract parameters and the calibration function as shown in Equation (3), Equation (4), and/or Equation (5).

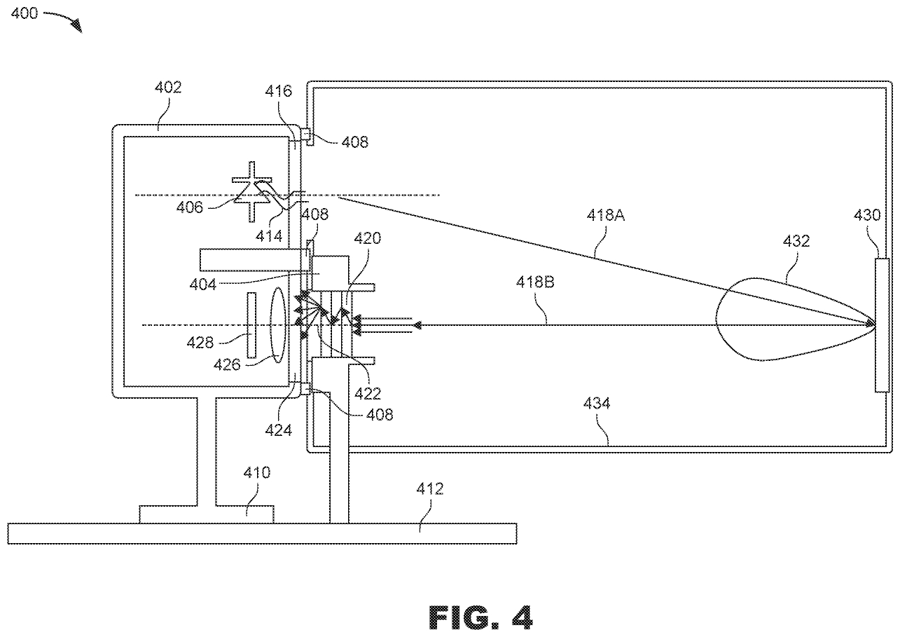

FIG. 4 is a diagram illustrating an example calibration system 400 for calibrating a TOF sensor system (e.g., TOF sensor 202), according to some examples of the present disclosure. In this example, the calibration system 400 can include a TOF sensor module 402 that is placed in contact with (e.g., in direct or indirect contact with) and/or is coupled to (e.g., is directly or indirectly coupled to) a calibration assembly 404. In some examples, the calibration assembly 404 can be mounted on and/or held/hosted/secured by a calibration table 412. For example, the calibration table 412 can be used to hold, secure, position, and/or align the calibration assembly 404 so the calibration assembly 404 is held and/or remains against the TOF sensor module 402, as shown in FIG. 4. In some examples, the TOF sensor module 402 can be the same as, part of, included in, and/or implemented by the TOF sensor 202 illustrated in FIG. 2. In other examples, the TOF sensor module 402 can be part of, included in, and/or implemented by another TOF sensor(s).

The TOF sensor module 402 can include a light source 406 and an optic window 416 (e.g., protective optic window). The light source 406 can include, for example and without limitation, a solid-state laser (e.g., a laser diode (LD), a vertical-cavity surface-emitting laser (VCSEL), etc.), a light-emitting diode (LED), etc.), a lamp, and/or any other light emitter or light emitting device. For example, in some cases, the light source 406 can include one or more VCSELs. The light source 406 can generate and transmit light 414 towards a target 430 contained and/or enclosed within an enclosure 434 of the calibration system 400. In some examples, the enclosure 434 can also contain and/or enclose the calibration assembly 404 and a narrow reflection cone 432, as further described below.

The light 414 from the light source 406 can travel through the optic window 416 of the TOF sensor module 402 and towards the target 430 in the enclosure 434. The transmitted light 418A from the light source 406 and the optic window 416 can travel to the target 430 along a path within the enclosure 434. The target 430 can reflect the light (e.g., reflected light 418B) with a narrow reflection cone 432. The reflected light 418B can travel towards one or more diffusers 420 of the calibration assembly 404. The one or more diffusers 420 can diffuse the reflected light 418B before it reaches the TOF chip 428, in order to generate homogenized light 422 with a homogeneous phase front based on the reflected light 418B. In some examples, the one or more diffusers 420 can diffuse the reflected light 418B, and the diffused light (e.g., the homogenized light 422 with the homogeneous phase front) can prevent or reduce/minimize inhomogeneity in the lens image mapping.

For example, the diffused light can prevent or reduce/minimize depth inhomogeneities (e.g., individual pixels receiving different depth measurements). In some cases, by diffusing the reflected light 418B, the one or more diffusers 420 can prevent or reduce/minimize input phase inhomogeneities (e.g., input equalization) as the pixels on the array can receive the light with superimposed and diffused wave fronts. The one or more diffusers 420 can also prevent or reduce/minimize an interference effect referred to as a laser speckle pattern. In some cases, the one or more diffusers 420 can include a single diffuser. In other cases, the one or more diffusers 420 can include a stack of diffusers (e.g., multiple diffusers). In some examples, a stack of diffusers may provide increased, more consistent, and/or stronger distribution/redistribution of the light and reduce or prevent a laser speckle effect, which can create an interference effect.

In some examples, to generate the homogenized light 422, the one or more diffusers 420 can scatter the reflected light 418B in such a way that the scattered light is homogenous (or significantly homogeneous) before the light passes through a lens window 424 and one or more lenses 426. As shown, the homogenized light 422 with the homogeneous phase front can then pass through the lens window 424 (e.g., a protective lens window) and the one or more lenses 426 on the TOF sensor module 402, towards the TOF chip 428. The TOF chip 428 can be the same as or different than the TOF sensor chip 314 shown in FIG. 3. Moreover, the homogenized light 422 with the homogeneous phase front, the lens window 424, and the one or more lenses 426 can distribute the light onto the TOF chip 428, with equal or quasi equal phase fronts that can be used for systematic calibration. By equalizing the phase front of the light, the calibration system 400 can calibrate (and/or more accurately calibrate) each pixel of the depth map generated by the TOF sensor module 402. For example, in some cases, each pixel (or multiple pixels) captured by the TOF sensor module 402 can have a different offset. To calibrate the different offsets (e.g., to calibrate each pixel), the calibration system 400 can apply a same scaler to the different offsets. The equalized phase front of the light can thus be used as the scaler used for such calibration of the different offsets.

The enclosure 434 of the calibration assembly 404 can ensure that the transmitted light 418A and the reflected light 418B are contained within the calibration system 400 and provide isolation from ambient light to prevent or limit noise caused by ambient light. In some examples, one or more of the interior surfaces of the enclosure 434 can be coated with an infrared (IR) light absorbing material, such as IR absorbing paint or any other IR absorbing material or coating. The IR light absorption material can prevent light within the enclosure 434 from reflecting from the interior surfaces of the enclosure 434 and creating multiple light paths, which can result in undefined light paths, cause calibration errors from signal path uncertainties, strayed light, crosstalk/coupling and associated signal distortions, etc.

In some examples, the calibration system 400 can include an isolation material 408, such as IR isolation rubber or any other IR isolation material. The isolation material 408 can be used to seal/contain the light (e.g., transmitted light 418A, reflected light 418B) within the enclosure 434 and/or create a seal between the enclosure 434, the TOF sensor module 402, and the calibration assembly 404. For example, the enclosure 434, the IR light absorbing material on the interior surfaces of the enclosure 434, and the isolation material 408 can prevent or limit noise from ambient light, prevent or limit stray light and multiple signal paths, prevent or limit signal crosstalk/coupling associated with stray light and multiple signal paths, and create a known and/or more certain path for the light (e.g., transmitted light 418A, reflected light 418B) used to calibrate the TOF sensor.

In some cases, the calibration system 400 can include a staging component 410 (e.g., xyz stage) coupled to the TOF sensor module 402. The staging component 410 can align/position/reposition the TOF sensor module 402 relative to the calibration assembly 404 and/or the isolation material 408. In some examples, the staging component 410 can be used to mechanically adjust the isolation pressure associated with the isolation material 408 as needed/desired.

As shown in FIG. 4, the calibration system 400 can provide a more controlled calibration environment, as well as more consistent and/or accurate TOF testing and calibration results. Moreover, the calibration system 400 can protect against noise from ambient light, prevent strayed light and associated crosstalk/coupling, prevent multiple light paths and provide a known or more certain light path to reduce calibration errors, distributing the modulated output from the light source with equal or quasi equal phase fronts for systematic calibration, and provide more stable, reliable, and accurate calibration results. In some cases, the calibration system can be modified to implement optical fiber used to create a known path for the modulated output from the light source, prevent/control and/or account for temperature effects on the calibration, and determine calibration/compensation offsets such as phase/time offsets.

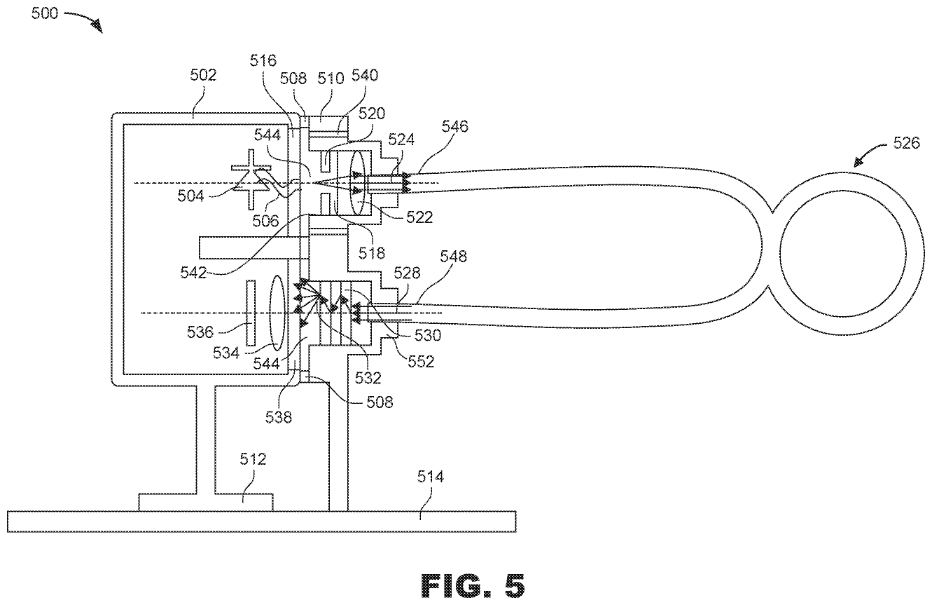

FIG. 5 is a diagram illustrating another example calibration system 500 for calibrating a TOF sensor (e.g., TOF sensor 202), according to some examples of the present disclosure. In this example, the calibration system 500 can include a TOF sensor module 502 that is placed in contact with (e.g., in direct or indirect contact with) and/or is coupled to (e.g., is directly or indirectly coupled to) a calibration assembly 510. In some examples, the calibration assembly 510 can be mounted on and/or held/hosted/secured by a calibration table 514. The calibration table 514 can be used to hold, secure, position, and/or align the calibration assembly 510 so the calibration assembly 510 is held and/or remains against the TOF sensor module 502, as shown in FIG. 5. In some examples, the TOF sensor module 502 can be the same as, part of, included in, and/or implemented by the TOF sensor 202 illustrated in FIG. 2. In other examples, the TOF sensor module 502 can be part of, included in, and/or implemented by another TOF sensor(s).

The TOF sensor module 502 can include a light source 504 and an optical window 516 (e.g., a protective optical window). The light source 504 can generate and transmit light 506 towards a fiber optic cable 526 (or bundle) that is coupled to the calibration assembly 510. The light source 504 can include, for example and without limitation, a solid-state laser (e.g., an LD, a VCSEL, etc.), an LED, etc.), a lamp, and/or any other light emitter or light emitting device. For example, in some cases, the light source 504 can include one or more VCSELs. In some cases, the fiber optic cable 526 can include a single fiber optic cable. In other cases, the fiber optic cable 526 can include/represent a fiber optic cable bundle (e.g., multiple optical fibers).

As shown in FIG. 5, a first end 546 of the fiber optic cable 526 can be coupled and/or connected to a transmit portion 550 (e.g., a transmit port, a transmit channel, a transmit path, etc.) of the calibration assembly 510, and a second end 548 of the fiber optic cable 526 can be coupled and/or connected to a receive portion 552 of the calibration assembly 510. The first end 546 of the fiber optic cable 526 can receive the light from the TOF sensor module 502 and the transmit portion 550 of the calibration assembly 510, and the second end 548 of the fiber optic cable 526 can allow the light carried by the fiber optic cable 526 to exit/travel/transfer to the receive portion 552 of the calibration assembly 510.

The light 506 from the light source 504 can travel through an optical window 516 (e.g., an optical protective window) of the TOF sensor module 502, to an aperture limiter 520 and a diffuser 518 on the transmit portion 550 of the calibration assembly 510. The aperture limiter 520 and diffuser 518 can serve as a homogeneous extended optical light source. For example, the aperture limiter 520 and diffuser 518 can homogenize the light 506 from the light source 504 and the optical window 516 as the light 506 travels through the aperture limiter 520 and diffuser 518 towards a coupling lens 522 on the transmit portion 550 of the calibration assembly 510. The coupling lens 522 can receive and collimate the homogenized light before the light enters the fiber optic cable 526 (e.g., via the first end 546 of the fiber optic cable 526), to generate collimated light 524. In some examples, the collimated light 524 can allow and/or improve calibration of the fiber optic cable 526.

The collimated light 524 can travel through the fiber optic cable 526 toward the receive portion 552 of the calibration assembly 510. The fiber optic cable 526 can protect the collimated light 524 from temperature effects (e.g., which can cause phase/time delays), create a known path for the collimated light 524 (e.g., which can enable more accurate sensor calibration), prevent stray rays and multiple light paths (e.g., unknown or uncertain light paths) as well as associated crosstalk/coupling (e.g., which can cause calibration errors, calibration uncertainties, noise, and/or phase/time delays), and/or otherwise provide a more stable/predictable, controlled, and/or contained environment for the collimated light 524.

The fiber optic cable 526 can be of any desired length. For example, various different fiber optic cable lengths can be used in different implementations. Thus, the fiber optic cable 526 can provide different or adjustable optical path lengths for the collimated light 524 depending on the selected length of the fiber optic cable 526. In some cases, the length of the fiber optic cable 526 can be reduced in order to reduce the overall size of the calibration system 500 and make the calibration system 500 more compact. In other words, the length of the fiber optic cable 526 can be selected at least in part on the desired size of the calibration system 500 and/or any constraints and/or goals regarding the size of the calibration system. In other cases, to reduce the overall size of the calibration system 500 and make the calibration system 500 more compact without reducing the actual length of the fiber optic cable 526 (or without reducing the length of the fiber optic cable 526 below a threshold length) and/or to implement a longer fiber optic cable 526 (and thus a longer optical path for the collimated light 524) without increasing the size of the calibration system 500 (or without increasing the size of the calibration system 500 beyond a threshold size), the fiber optic cable 526 can be arranged and/or configured to limit how far the fiber optic cable 526 extends from end to end without necessarily reducing the actual end-to-end length of the fiber optic cable 526. In some cases, the fiber optic cable 526 can include fiber optic cables of multiple lengths, which can be used to characterize the system response at various “distances”, therefore calibrating the distance response non-uniformity (DRNU) without the use of an internal delayed locking loop (DLL).

For example, at least a portion of the fiber optic cable 526 can be coiled, bent, spiraled, curled, wound/winded, arched, folded, and/or otherwise shaped/reshaped to reduce the amount of space used by the fiber optic cable 526 along any direction(s)/plane(s) without actually having to reduce the length of the fiber optic cable 526. To illustrate, in the example shown in FIG. 5, a portion of the fiber optic cable 526 is arranged/configured in a loop to reduce the length of the space used by the fiber optic cable 526 without actually reducing the total length of the fiber optic cable 526. Here, the looped portion of the fiber optic cable 526 can reduce the effective length of the fiber optic cable 526 (e.g., relative to the actual length of the fiber optic cable 526) without reducing the actual length of the fiber optic cable 526 from end to end. This way, the amount of space used by the fiber optic cable 526 and the calibration system 500 can be compacted/reduced without reducing the total length of the fiber optic cable 526 (and thus the optical path for the collimated light 524) or negatively impacting a performance of the calibration system 500. However, by shaping, arranging, and/or configuring the fiber optic cable 526 as described herein, the effective length of the fiber optic cable 526 can be reduced (e.g., as well as the size of the calibration system 500) without reducing the actual length of the fiber optic cable 526 so the fiber optic cable 526 is not below the threshold length.

For example, if the length of the fiber optic cable 526 (and the length of the optical path for the collimated light 524) is below a threshold length, the accuracy and/or performance of the calibration system 500 may, in some cases, be negatively impacted. To illustrate, in some cases, for the TOF sensor module 502 to obtain TOF measurements (and/or more accurate TOF measurements), the fiber optic cable 526 may need to have at least a certain length (e.g., a threshold length) to provide a certain distance for the light used to obtain the measurements. Thus, by shaping, arranging, and/or configuring the fiber optic cable 526 as described herein, the effective length of the fiber optic cable 526 can be reduced (e.g., as well as the size of the calibration system 500) without also reducing the actual length of the fiber optic cable 526, in order to increase the distance traveled by the light (e.g., as a result of the longer length of the fiber optic cable 526) without increasing the size of the calibration system 500. In some cases, the length of the fiber optic cable 526 selected to achieve more accurate TOF measurements can depend on the pulse width associated with the light.

The collimated light 524 can travel from a second end 548 of the fiber optic cable 526 to one or more diffusers 530 on the receive portion 552 of the calibration assembly 510. The one or more diffusers 530 can diffuse the collimated light 524 before it reaches the TOF chip 536, in order to generate homogenized light 532 with a homogeneous phase front from the collimated light 524. The homogenized light 532 with the homogeneous phase front can pass through a lens window 538 and one or more lenses 534 of the TOF sensor module 502, towards the TOF chip 536. The homogenized light 532 with the homogeneous phase front, the lens window 538, and the one or more lenses 534 can distribute the light onto the TOF chip 536 with equal or quasi equal phase fronts for systematic calibration. The equalized phase front of the light can allow the calibration system 500 to calibrate (and/or more accurately calibrate) each pixel in the depth map generated by the TOF sensor module 502. For example, in some cases, each pixel (or multiple pixels) captured by the TOF sensor module 502 can have a different offset. To calibrate the different offsets (e.g., to calibrate each pixel), the calibration system 500 can apply a same scaler to the different offsets. The equalized phase front of the light can thus be used as the scaler used for such calibration of the different offsets.

In some examples, the one or more diffusers 530 can diffuse the collimated light 524, and the diffused light (e.g., the homogenized light 532 with the homogeneous phase front) can prevent or reduce/minimize inhomogeneity in the lens image mapping. For example, the diffused light can prevent or reduce/minimize depth inhomogeneities (e.g., individual pixels receiving different depth measurements). In some cases, by diffusing the collimated light 524, the one or more diffusers 530 can prevent or reduce/minimize input phase inhomogeneities (e.g., input equalization) as the pixels on the array can receive the light with superimposed and diffused wave fronts. In some examples, to generate the homogenized light 532, the one or more diffusers 530 can scatter the collimated light 524 in such a way that the scattered light is homogenous (or significantly homogeneous) before the light passes through the lens window 538 and the one or more lenses 534.

The one or more diffusers 530 can also prevent or reduce/minimize an interference effect referred to as a laser speckle pattern. In some cases, the one or more diffusers 530 can include a single diffuser. In other cases, the one or more diffusers 530 can include a stack of diffusers (e.g., multiple diffusers). In some examples, a stack of diffusers may provide increased, more consistent, and/or stronger distribution/redistribution of the light and reduce or prevent a laser speckle effect, which can create an interference effect.

In some cases, the calibration assembly 510 can include one or more cavities used to enable some amount of thermal drainage and/or partial light leakage as desired. For example, the transmit portion 550 of the calibration assembly 510 can include one or more cavities 540 configured to allow a certain amount of thermal ventilation by air blowing, drainage, and/or partial light leakage from the calibration system 500. In some aspects, the transmit portion 550 of the calibration assembly 510 can include an amount of spacing 544 which, in some examples, can be an adjustable space that can be modified (e.g., reduced, increased, resized, reconfigured/reshaped, removed, etc.) to affect/modify, reduce, prevent, and/or control/manage any thermal effects on the light 506 passing through the transmit portion 550 of the calibration assembly 510. When the light 506 exits the optical window 516 on the TOF sensor module 502 and onto the transmit portion 550 of the calibration assembly 510, the light 506 can travel through any spacing (e.g., spacing 544) along/within/about an optical axis, before transferring to the fiber optic cable 526 from the first end 546 of the fiber optic cable 526.

In some examples, the calibration system 500 can include one or more portions of isolation material 508 (e.g., one or more pieces, blocks, segments, wedges, spacers, fragments, slices, items, shapes, solids, gaskets, strips, linings, sealants, bonds, binders, epoxies, sealants/sealers, compounds, adhesives, etc.), such as IR isolation rubber or any other IR isolation material, which can be placed (e.g., located, positioned, secured, wedged, etc.) between, and in contact with, the TOF sensor module 502 and the calibration assembly 510. For example, the calibration system 500 can include isolation material that has one side (e.g., a surface of one side) in contact with a surface or interface of the TOF sensor module 502 and another side (e.g., a surface of another side) in contact with a surface or interface of the calibration assembly 510. The isolation material 508 can be used to create a seal between the calibration assembly 510 and the TOF sensor module 502 and thereby seal/contain light within the calibration system 500 to prevent, reduce, modify, and/or control/manage any leakage of light emitted by the light source 504 as well as any leakage of light from an external environment (e.g., ambient light, etc.) into an optical path of/in the calibration system 500.

For example, the isolation material 508 can provide a seal between the TOF sensor module 502 and the calibration assembly 510 to avoid/prevent, reduce/limit, modify, and/or control/manage any leakage of the light emitted by the light source 504, prevent or limit noise from ambient light in the external environment (e.g., by preventing ambient light in the external environment from entering the calibration system 500 and/or entering an optical path in the calibration system 500 for the light emitted by the light source 504), prevent or limit stray light caused by reflections of the light emitted by the light source 504 and/or light from external sources such as ambient light in the external environment, prevent or limit signal crosstalk/coupling that may otherwise potentially result from light reflections and/or stray light (e.g., from external sources such as ambient light in the external environment), etc.

In some cases, the calibration system 500 can include a portion of isolation material (e.g., isolation material 508) that is in contact with (and creates a seal between) a surface of the transmit portion 550 of the calibration assembly 510 (e.g., a surface facing the TOF sensor module 502) and a surface of the TOF sensor module 502 (e.g., a surface of the TOF sensor module 502 that is adjacent to the surface of the transmit portion 550 that is in contact with the portion of isolation material), and a portion of isolation material (e.g., isolation material 508) that is in contact with (and creates a seal between) a surface of the receive portion 552 of the calibration assembly 510 (e.g., a surface facing the TOF sensor module 502) and a surface of the TOF sensor module 502 (e.g., a surface of the TOF sensor module 502 that is adjacent to the surface of the transmit portion 550 that is in contact with the portion of isolation material).

For example, the calibration system 500 can include a portion of isolation material (e.g., isolation material 508) that, on a first side, is in contact with (and creates a seal between) a surface of the TOF sensor module 502 that is above the optical window 516 of the TOF sensor module 502 and faces towards the calibration assembly 510 (e.g., when the calibration system 500 is assembled) and, on a second side, is in contact with a surface of a portion of the transmit portion 550 of the calibration assembly 510 that faces the TOF sensor module 502 (e.g., when the calibration system 500 is assembled) and is located adjacent to the surface of the TOF sensor module 502 that is in contact with the first side of the portion of isolation material, such that the portion of isolation material is placed between, and makes contact with, a surface of the TOF sensor module 502 and a surface of the transmit portion 550 of the calibration assembly 510. The calibration system 500 can also include a different portion of isolation material (e.g., isolation material 508) that faces towards the calibration assembly 510 (e.g., when the calibration system 500 is assembled) and, on a first side, is in contact with (and creates a seal between) a surface of the TOF sensor module 502 that is below the optical window 538 of the TOF sensor module 502 and, on a second side, is in contact with a surface of a portion of the receiving portion 552 of the calibration assembly 510 that faces the TOF sensor module 502 (e.g., when the calibration system 500 is assembled) and is located adjacent to the surface of the TOF sensor module 502 that is in contact with the first side of the different portion of isolation material, such that the different portion of isolation material is placed between (and makes contact with) a surface of the TOF sensor module 502 and a surface of the receive portion 552 of the calibration assembly 510.

In some examples, the calibration system 500 can include more or less portions of isolation material placed in contact with other surfaces of the TOF sensor module 502 and the calibration assembly 510. For example, in some cases, the calibration system 500 can also include a portion of isolation material (e.g., isolation material 508) that, on a first side, is in contact with (and creates a seal between) a surface of the TOF sensor module 502 that is below the optical window 516 of the TOF sensor module 502 and above the optical window 538 of the TOF sensor module 502 (e.g., and faces towards the calibration assembly 510 when the calibration system 500 is assembled) and, on a second side, is in contact with a surface of the calibration assembly 510 that faces the TOF sensor module 502 (e.g., when the calibration system 500 is assembled) and is located adjacent to the surface of the TOF sensor module 502 that is in contact with the first side of the portion of isolation material (e.g., a portion of the calibration assembly 510 that is between the transmit portion 550 of the calibration assembly 510 and the receive portion 552 of the calibration assembly 510), such that the portion of isolation material is placed between, and makes contact with, other portions of the TOF sensor module 502 and the calibration assembly 510.

of the calibration assembly 510 (e.g., a surface facing the TOF sensor module 502) and a surface of the TOF sensor module 502 (e.g., a surface of the TOF sensor module 502 that is adjacent to the surface of the transmit portion 550 that is in contact with the portion of isolation material), and a portion of isolation material (e.g., isolation material 508) that is in contact with (and creates a seal between) a surface of the receive portion 552 of the calibration assembly 510 (e.g., a surface facing the TOF sensor module 502) and a surface of the TOF sensor module 502 (e.g., a surface of the TOF sensor module 502 that is adjacent to the surface of the transmit portion 550 that is in contact with the portion of isolation material).

In some examples, the calibration system 500 can include a staging component 512 (e.g., xyz stage) coupled to the TOF sensor module 502. In some cases, the staging component 512 can align/position/reposition the TOF sensor module 502 relative to the calibration assembly 510 and/or the isolation material 508. In some examples, the staging component 512 can be used to mechanically adjust the isolation pressure associated with the isolation material 508 as needed/desired. Adjusting the isolation pressure can help improve isolation of the light and thus prevent light leakage, stray light (and associated interference, crosstalk/coupling, etc.), prevent multiple light paths (and/or undefined light paths), etc.

In some cases, an interior surface 542 of the calibration assembly 510 can be coated with an IR light absorbing material, such as IR absorbing paint or any other IR absorbing material or coating. The IR light absorption material can prevent light within the calibration assembly 510 from reflecting from the interior surface of the calibration assembly 510, which can cause strayed light, crosstalk/coupling and associated signal distortions, calibration errors, etc.

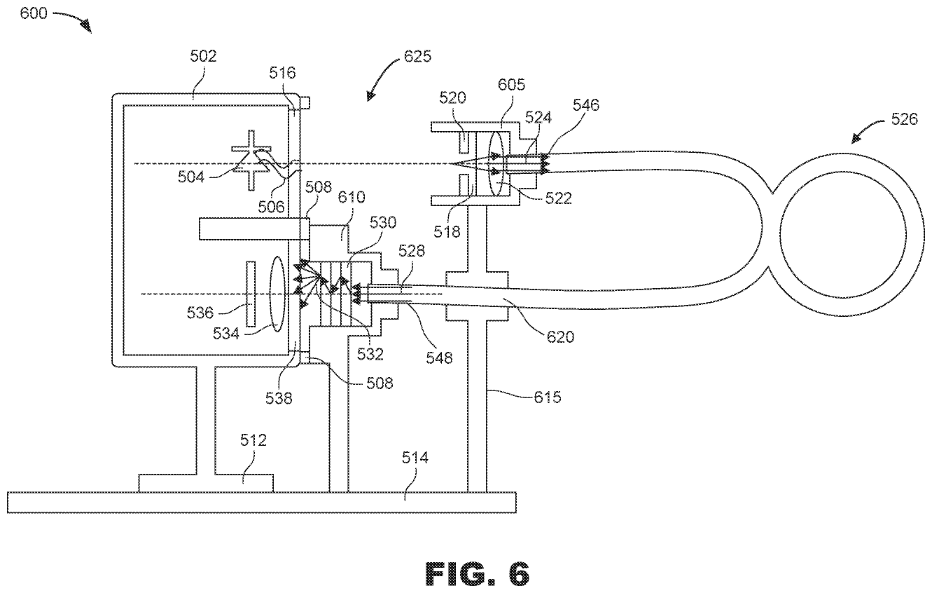

As shown in FIG. 5, the calibration system 500 can provide a more controlled calibration environment, as well as more consistent and accurate TOF testing and calibration results. Moreover, the calibration system 500 can protect against noise from ambient light, prevent strayed light and associated crosstalk/coupling, prevent multiple and/or unknown optical paths and provide a known optical path for light to reduce calibration errors, distribute the modulated output from the light source with equal or quasi equal phase fronts for systematic calibration, and provide more stable, reliable, and accurate calibration results. In some cases, the calibration system 500 with the optical fiber can be modified and/or simplified in various ways, as further described below with respect to FIGS. 6 through 8.

FIG. 6 is a diagram illustrating another example calibration system 600 for calibrating a TOF sensor (e.g., TOF sensor 202), according to some examples of the present disclosure. In this example, the calibration system 600 can includes a calibration assembly 605 along a transmit light path and a calibration assembly 610 along a receive light path. The calibration system 600 can also include an isolation material 508, such as IR isolation rubber or any other IR isolation material, used to create a seal between the calibration assembly 610 and the TOF sensor module 502, in order to seal/contain light passing from the calibration assembly 610 to the TOF sensor module 502.

Moreover, the calibration system 600 can include an opening 625 and space between the TOF sensor module 502 and the calibration assembly 605 on the transmit light path. Thus, the calibration system 600 does not include a seal between the TOF sensor module 502 and the calibration assembly 605 on the transmit light path. The space and separation between the TOF sensor module 502 and the calibration assembly 605 created by the opening 625 can prevent or reduce potential reflections of the light 506 emitted by the light source 504 of the TOF sensor module 502 and any associated instabilities due to the near field reflection. For example, since the light 506 from the light source 504 is not fully enclosed when traveling between the optical window 516 on the TOF sensor module 502 and the calibration assembly 605, such configuration may prevent or limit light reflections on any surfaces of the calibration assembly 605 if the light was instead fully enclosed along the path from the optical window 516 and the calibration assembly 605.

In some examples, the calibration assembly 605 and/or the calibration assembly 610 can be mounted on and/or held/hosted/secured by a calibration table 514. The calibration table 514 can be used to hold, secure, position, and/or align the calibration assembly 605 and/or the calibration assembly 610, and ensure that the calibration assembly 610 is held and/or remains against the TOF sensor module 502, as shown in FIG. 6.

The TOF sensor module 502 can include the light source 504 and the optical window 516 (e.g., a protective optical window). The light source 504 can emit light 506 towards a fiber optic cable 526 (or bundle) that is coupled to the calibration assembly 605. A first end 546 of the fiber optic cable 526 can be coupled and/or connected to the calibration assembly 605, and a second end 548 of the fiber optic cable 526 can be coupled and/or connected to the calibration assembly 610. The first end 546 of the fiber optic cable 526 can receive the light 506 from the TOF sensor module 502 and the calibration assembly 605, and the second end 548 of the fiber optic cable 526 can allow the light carried by the fiber optic cable 526 to exit/travel/transfer to the calibration assembly 605.

The light 506 from the light source 504 can travel through an optical window 516 (e.g., an optical protective window) of the TOF sensor module 502, to an aperture limiter 520 and a diffuser 518 on the calibration assembly 605. The aperture limiter 520 and diffuser 518 can serve as a homogeneous extended optical light source. For example, the aperture limiter 520 and diffuser 518 can homogenize the light 506 from the light source 504 and the optical window 516 as the light 506 travels through the aperture limiter 520 and diffuser 518 towards a lens 522 on the calibration assembly 605. The lens 522 can receive and collimate the homogenized light before the light enters the fiber optic cable 526 (e.g., via the first end 546 of the fiber optic cable 526), to generate collimated light 524.

The collimated light 524 can travel through the fiber optic cable 526 toward the calibration assembly 610. The fiber optic cable 526 can protect the collimated light 524 from temperature effects (e.g., which can cause phase/time delays), create a known path for the collimated light 524 (e.g., which can enable more accurate sensor calibration), prevent stray rays and multiple light paths (e.g., unknown or uncertain light paths) as well as associated crosstalk/coupling (e.g., which can cause calibration errors, calibration uncertainties, noise, and/or phase/time delays), and/or otherwise provide a more stable/predictable, controlled, and/or contained environment for the collimated light 524.

The fiber optic cable 526 can be of any desired length. For example, various different fiber optic cable lengths can be used in different implementations. Thus, the fiber optic cable 526 can provide different or adjustable optical path lengths for the collimated light 524 depending on the selected length of the fiber optic cable 526. In some cases, the length of the fiber optic cable 526 can be reduced in order to reduce the overall size of the calibration system 600 and make the calibration system 600 more compact, as previously described with respect to the fiber optic cable 526 in FIG. 5.

The collimated light 524 can travel from a second end 548 of the fiber optic cable 526 to one or more diffusers 530 on the calibration assembly 610. The one or more diffusers 530 can diffuse the collimated light 524 before it reaches the TOF chip 536, in order to generate homogenized light 532 with a homogeneous phase front from the collimated light 524. The homogenized light 532 with the homogeneous phase front can pass through a lens window 538 and one or more lenses 534 of the TOF sensor module 502, towards the TOF chip 536. The homogenized light 532 with the homogeneous phase front, the lens window 538, and the one or more lenses 534 can distribute the light onto the TOF chip 536 with equal or quasi equal phase fronts for systematic calibration.

In some cases, the optical table can include a stand 615 for holding, securing, and/or aligning the calibration assembly 605. For example, if the light source 504 and the TOF chip 536 are vertically and/or symmetrically aligned/arranged, the stand 615 can be used to provide alignment of the calibration assembly 605 and/or a portion of the fiber optic cable 526. In some cases, the stand 615 can include a path 620 (e.g., a hole or cavity, etc.) for a portion of the fiber optic cable 526 to pass through the stand 615 towards the calibration assembly 610 and/or align the second end 548 of the fiber optic cable 526 with the calibration assembly 610.

In some examples, the calibration system 600 can include a staging component 512 (e.g., xyz stage) coupled to the TOF sensor module 502. In some cases, the staging component 512 can align/position/reposition the TOF sensor module 502 relative to the calibration assembly 610 and/or the isolation material 508. In some examples, the staging component 512 can be used to mechanically adjust the isolation pressure associated with the isolation material 508 as needed/desired.

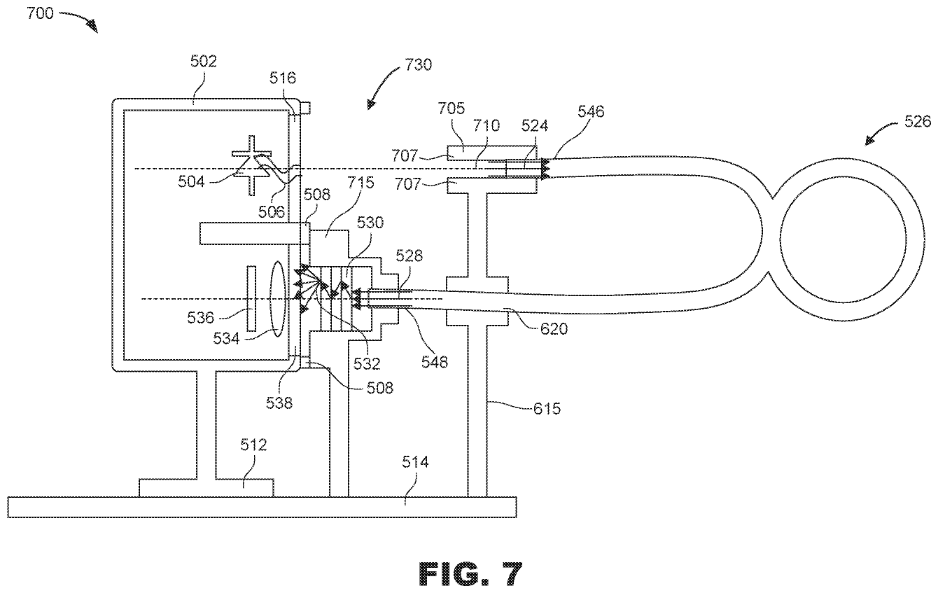

FIG. 7 is a diagram illustrating another example calibration system 700 for calibrating a TOF sensor (e.g., TOF sensor 202), according to some examples of the present disclosure. The calibration system 700 in this example is similar to the calibration system 600 shown in FIG. 6. For example, like the calibration system 600 shown in FIG. 6, the calibration system 700 in this example includes a calibration assembly 705 along a transmit light path, which also has an opening 730 that provides space between the calibration assembly 705 and the TOF sensor module 502 to prevent or limit light reflections and multiple light paths, and a calibration assembly 715 along the receive light path that is coupled to an isolation material 508 used to create a seal between the calibration assembly 715 and the TOF module 502, in order to seal/contain light passing from the calibration assembly 715 to the TOF module 502.

However, the calibration assembly 705 on the transmit light path does not include an aperture limiter, a diffuser, or a lens used to transmit the collimated light 524. Instead, the calibration assembly 705 includes an optic pupil 710 on a tube 707 of the calibration assembly 705, which provides a path for the collected light 524 to reach/enter the first end 546 of the fiber optic cable 526. In some examples, the length of the tube 707 of calibration assembly 705 can be increased (e.g., relative to the length of the receiving portion of the calibration assembly 510 in FIG. 5) as the longer tube can limit or reduce the entrance angle of the light (e.g., from the light source 504) received by the calibration assembly 705 so that the collected light behaves and/or is shaped like collimated light. The collected light 524 can then travel through the fiber optic cable 526 toward the calibration assembly 715 coupled to the second end 548 of the fiber optic cable 526. At the calibration assembly 715, the collected light 524 can be diffused by the one or more diffusers 530. The one or more diffusers 530 can generate homogenized light 532 with a homogeneous phase front from the collimated light 524. The homogenized light 532 with the homogeneous phase front can then pass through a lens window 538 and one or more lenses 534 on the TOF sensor module 502, towards the TOF chip 536. The homogenized light 532 with the homogeneous phase front, the lens window 538, and the one or more lenses 534 can distribute the light onto the TOF chip 536 with equal or quasi equal phase fronts for systematic calibration.

The simplifications described above with respect to the calibration system 700 can reduce the thermal related issues associated with using a higher power light source (e.g., a higher power VCSEL), as well the costs and/or difficulty of manufacturing the calibration system 700, while providing a stable/reliable calibration environment and accurate calibration tests and results.

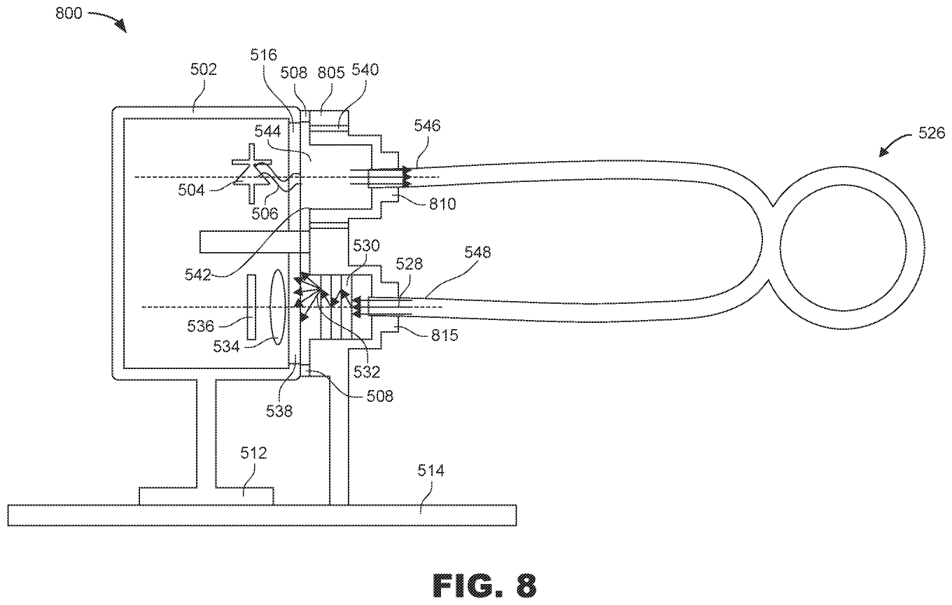

FIG. 8 is a diagram illustrating another example calibration system 800 for calibrating a TOF sensor (e.g., TOF sensor 202), according to some examples of the present disclosure. The calibration system 800 in this example is similar to the calibration system 500 shown in FIG. 5. However, as shown in FIG. 8, the calibration system 800 can be simplified (e.g., relative to the calibration system 500 shown in FIG. 5) by removing one or more components of the calibration system such as, for example, the one or more diffusers (e.g., the one or more diffusers 518 in FIG. 5) on the transmit portion (e.g., transmit portion 550 in FIG. 5) of the calibration assembly (e.g., calibration assembly 510 in FIG. 5) of the calibration system (e.g., calibration system 500 shown in FIG. 5), the aperture limiter (e.g., aperture limiter 520 in FIG. 5) on the transmit portion of the calibration assembly of the calibration system (e.g., calibration system 500), and/or the lens (e.g., lens 522) on the transmit portion of the calibration assembly of the calibration system (e.g., calibration system 500).

For example, like the calibration system 500 shown in FIG. 5, the calibration system 800 in this example includes a calibration assembly 805 that is coupled to (e.g., directly or indirectly) the TOF sensor module 502, and one or more portions of isolation material (e.g., isolation material 508, such as IR isolation rubber or any other IR isolation material,) used to seal/contain light emitted by the light source 504 as the light travels through the calibration system 500 (e.g., from the light source 506 on the TOF sensor module 502 to a transmit portion 810 of the calibration assembly 805 and the fiber optic cable 526, and from the fiber optic cable 526 to a receive portion 815 of the calibration assembly 805 and the TOF sensor chip 536 on the TOF sensor module 502), and/or to create one or more seals between the calibration assembly 805 and the TOF sensor module 502. Moreover, like the calibration assembly 510 in FIG. 5, the calibration assembly 805 includes a transmit portion 805 configured to receive light 506 emitted by the light source 504 on the TOF sensor module 502 before the light passes to the fiber optic cable 526, and a receive portion 815 configured to receive light (e.g., collimated light 524) from the fiber optic cable 526 before the light passes to one or more diffusers 530 on the receive portion 815 of the calibration assembly 805.

In some examples, the calibration system 800 can also include one or more portions of isolation material 508 placed (e.g., located, positioned, secured, wedged, etc.) between, and in contact with, the TOF sensor module 502 and the calibration assembly 510. For example, the calibration system 500 can include one or more portions of isolation material, with each portion of isolation material having one side (e.g., a surface of one side) that is in contact with a surface of the TOF sensor module 502 and another side (e.g., a surface of another side) that is in contact with a surface of the calibration assembly 510. The one or more portions of isolation material 508 can be used to create a seal between the calibration assembly 510 and the TOF sensor module 502 and thereby seal/contain light within the calibration system 500 to prevent, reduce, modify, and/or control/manage any leakage of light emitted by the light source 504 as well as any leakage of light from an external environment (e.g., ambient light, etc.) into an optical path of/in the calibration system 500.

As shown in FIG. 8, the light 506 emitted by the light source 504 on the TOF sensor module 502 can pass through the optical window 516 on the TOF sensor module 502 and the transmit portion 810 of the calibration assembly 805, onto the fiber optic cable 526. The light 506 from the light source 504 can enter the fiber optic cable 526 via the first end 546 of the fiber optic cable 526, which is coupled to the transmit portion 810 of the calibration assembly 805. In some examples, the transmit portion 810 of the calibration assembly 805 can include spacing 544 which, in some cases, can be adjusted (e.g., reduced, increased, resized, reconfigured/reshaped, removed, etc.) to reduce, prevent, modify, or control any thermal effects on the light 506 passing through the transmit portion 810 of the calibration assembly 805. When the light 506 exits the optical window 516 on the TOF sensor module 502 onto the transmit portion 810 of the calibration assembly 805, the light 506 can travel through the spacing 544 along/within/about an optical axis, before passing to the fiber optic cable 526 from the first end 546 of the fiber optic cable 526.

The light 506 can travel through the fiber optic cable 526 and pass from the fiber optic cable 526 to a receive portion 815 of the calibration assembly 805 that is coupled to the second end 548 of the fiber optic cable 526. At the receive portion 815 of the calibration assembly 805, the light can be diffused by the one or more diffusers 530. The one or more diffusers 530 can generate homogenized light 532 with a homogeneous phase front from the received light. The homogenized light 532 with the homogeneous phase front can then pass through a lens window 538 and one or more lenses 534 on the TOF sensor module 502, towards the TOF chip 536. The homogenized light 532 with the homogeneous phase front, the lens window 538, and the one or more lenses 534 can distribute the light onto the TOF chip 536 with equal or quasi equal phase fronts for systematic calibration.

The simplifications described above with respect to the calibration system 800 can reduce the costs and/or difficulty of manufacturing the calibration system 800, while providing a stable/reliable calibration environment and accurate calibration tests and results.

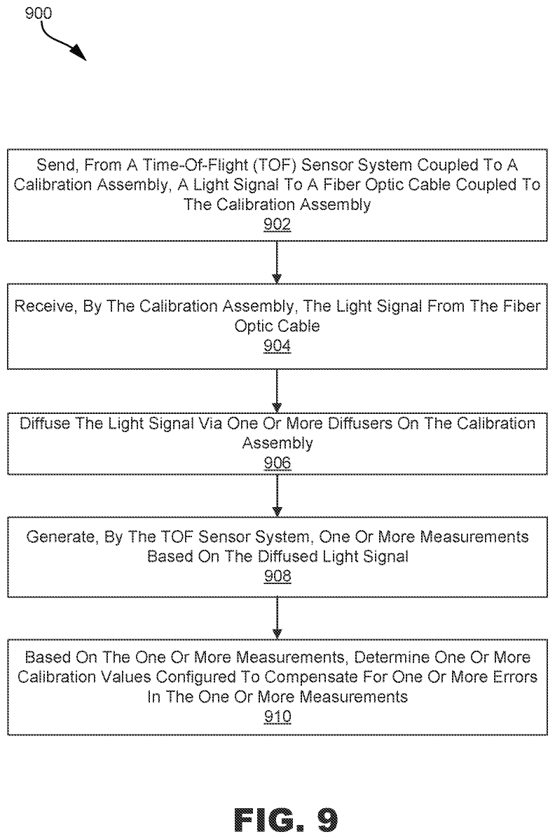

FIG. 9 is a flowchart illustrating an example process 900 for calibrating a TOF sensor (e.g., TOF sensor 202), according to some examples of the present disclosure. At block 902, the process 900 can include sending, from a TOF sensor system (e.g., TOF sensor 202, TOF sensor module 502) coupled to a calibration assembly (e.g., calibration assembly 510, calibration assembly 605, calibration assembly 610, calibration assembly 705, calibration assembly 715, calibration assembly 805), a light signal (e.g., light 506) to a fiber optic cable (e.g., fiber optic cable 526) coupled to the calibration assembly. For example, a light source (e.g., light source 504) of the TOF sensor system can emit the light signal, which can travel from the TOF sensor system to the calibration assembly, and from the calibration assembly to the fiber optic cable coupled to the calibration assembly.

In some examples, a first end of the fiber optic cable (e.g., first end 546) can be coupled to a first portion (e.g., transmit portion 550) of the calibration assembly and a second end (e.g., second end 548) of the fiber optic cable can be coupled to a second portion (e.g., receive portion 552) of the calibration assembly. In some cases, the first portion of the calibration assembly can be coupled to a portion of the TOF sensor system that includes a first optical path from a light source of the TOF sensor system to the first portion of the calibration assembly, and the second portion of the calibration assembly can be coupled to a different portion of the TOF sensor system that includes a second optical path from the second portion of the calibration assembly to a TOF sensor chip (e.g., TOF sensor chip 536) of the TOF sensor system. In some aspects, the first portion of the calibration assembly can include an aperture limiter (e.g., aperture limiter 540), which can be adjustable; a diffuser (e.g., one or more diffusers 518), a lens (e.g., lens 522), and/or the first end of the fiber optic cable. In some cases, the second portion of the calibration assembly can include the second end of the fiber optic cable and the one or more diffusers (e.g., one or more diffusers 530).

In some aspects, one or more interior surfaces of the calibration assembly can be coated with a light absorbing material.

At block 904, the process 900 can include receiving, by the calibration assembly, the light signal from the fiber optic cable. For example, the calibration assembly can receive the light signal from the fiber optic cable at a different portion of the calibration assembly than the portion of the calibration assembly that received the light signal from the TOF sensor system.

At block 906, the process 900 can include diffusing the light signal via one or more diffusers (e.g., one or more diffusers 530) on the calibration assembly. In some examples, diffusing the light signal can include scattering the light signal to generate homogenized light (e.g., homogenized light 532) with a homogeneous phase front. Here, the diffused light signal can include the homogenized light with the homogeneous phase front.

At block 908, the process 900 can include generating, by the TOF sensor system, one or more measurements based on the diffused light signal. For example, the TOF sensor system can use the diffused light signal to generate one or more distance measurements.

At block 910, the process 900 can include determining, based on the one or more measurements, one or more calibration values configured to compensate for one or more errors in the one or more measurements. In some examples, the one or more calibration values can be configured to compensate for a phase delay associated with the one or more measurements, a time delay associated with the one or more measurements, pixel-to-pixel variations, and/or a temperature effect on the one or more measurements.

In some aspects, the process 900 can include coupling the calibration assembly to the TOF sensor system. In some examples, the coupling can be configured to create a seal between the calibration assembly and the TOF sensor system. The seal can be configured to contain the light signal within an optical path from the TOF sensor system to the calibration assembly and/or an enclosed space between the TOF sensor system and the calibration assembly. The seal can also be configured to prevent or limit light from an external environment outside of the optical path or the enclosed space from entering the optical path or the enclosed space.

In some cases, coupling the calibration assembly to the TOF sensor system can include applying one or more sealants (e.g., isolation material 508) at one or more interfacing locations between the TOF sensor system and the calibration assembly. In some examples, a first side of each sealant of the one or more sealants can be placed in contact with a surface of the TOF sensor system and a second side of the sealant can be placed in contact with a surface of the calibration assembly. In some cases, each of the one or more sealants can include a light isolation material, and the one or more sealants at the one or more interfacing locations between the TOF sensor system and the calibration assembly can create at least part of the seal between the calibration assembly and the TOF sensor system.

In some aspects, a first end of the fiber optic cable can be coupled to a first portion of the calibration assembly and a second end of the fiber optic cable can be coupled to a second portion of the calibration assembly, and a length of the fiber optic cable can be greater than a threshold length. In some examples, at least a portion of the fiber optic cable can be at least partially curved, at least partially looped, at least partially bent, or at least partially coiled.

FIG. 10 illustrates an example processor-based system with which some aspects of the subject technology can be implemented. For example, processor-based system 1000 can be any computing device making up local computing device 110, datacenter 150, a passenger device (e.g., client computing device 170) executing the ridehailing application 172, or any component thereof in which the components of the system are in communication with each other using connection 1005. Connection 1005 can be a physical connection via a bus, or a direct connection into processor 1010, such as in a chipset architecture. Connection 1005 can also be a virtual connection, networked connection, or logical connection.

In some examples, computing system 1000 is a distributed system in which the functions described in this disclosure can be distributed within a datacenter, multiple data centers, a peer network, etc. In some cases, one or more of the described system components represents many such components each performing some or all of the function for which the component is described. In some cases, the components can be physical or virtual devices.

Example system 1000 includes at least one processing unit (CPU or processor) 1010 and connection 1005 that couples various system components including system memory 1015, such as read-only memory (ROM) 1020 and random-access memory (RAM) 1025 to processor 1010. Computing system 1000 can include a cache of high-speed memory 1012 connected directly with, in close proximity to, and/or integrated as part of processor 1010.

Processor 1010 can include any general-purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 can include an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms known to those of skill in the art. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 1030 can include software services, servers, services, etc., that when the code that defines such software is executed by the processor 1010, causes the system to perform a function. In some examples, a hardware service that performs a particular function can include the software component stored in a computer-readable medium in connection with the necessary hardware components, such as processor 1010, connection 1005, output device 1035, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: sending, from a time-of-flight (TOF) sensor system coupled to a calibration assembly, a light signal to a fiber optic cable coupled to the calibration assembly; receiving, by the calibration assembly, the light signal from the fiber optic cable; diffusing the light signal via one or more diffusers on the calibration assembly; generating, by the TOF sensor system, one or more measurements based on the diffused light signal; and based on the one or more measurements, determining one or more calibration values configured to compensate for one or more errors in the one or more measurements.

Aspect 2. The method of Aspect 1, wherein diffusing the light signal comprises scattering the light signal to generate homogenized light with a homogeneous phase front, wherein the diffused light signal comprises the homogenized light with the homogeneous phase front.

Aspect 3. The method of any of Aspects 1 or 2, further comprising coupling the calibration assembly to the TOF sensor system, wherein the coupling is configured to create a seal between the calibration assembly and the TOF sensor system, wherein the seal contains the light signal within at least one of an optical path from the TOF sensor system to the calibration assembly and an enclosed space between the TOF sensor system and the calibration assembly, and wherein the seal prevents light from an external environment outside of the optical path or the enclosed space from entering the optical path or the enclosed space.

Aspect 4. The method of Aspect 3, wherein coupling the calibration assembly to the TOF sensor system further comprises applying one or more sealants at one or more interfacing locations between the TOF sensor system and the calibration assembly, wherein a first side of each sealant of the one or more sealants is placed in contact with a surface of the TOF sensor system and a second side of the sealant is placed in contact with a surface of the calibration assembly, wherein each of the one or more sealants comprises a light isolation material, and wherein the one or more sealants at the one or more interfacing locations between the TOF sensor system and the calibration assembly create at least part of the seal between the calibration assembly and the TOF sensor system.

Aspect 5. The method of any of Aspects 1 to 4, wherein a first end of the fiber optic cable is coupled to a first portion of the calibration assembly and a second end of the fiber optic cable is coupled to a second portion of the calibration assembly, wherein the first portion of the calibration assembly is coupled to a portion of the TOF sensor system that includes a first optical path from a light source of the TOF sensor system to the first portion of the calibration assembly, and wherein the second portion of the calibration assembly is coupled to a different portion of the TOF sensor system that includes a second optical path from the second portion of the calibration assembly to a TOF sensor chip of the TOF sensor system.

Aspect 6. The method of Aspect 5, wherein the first portion of the calibration assembly comprises at least one of an aperture limiter, a diffuser, a lens, and the first end of the fiber optic cable, and wherein the second portion of the calibration assembly comprises at least one of the second end of the fiber optic cable and the one or more diffusers.

Aspect 7. The method of any of Aspects 1 to 6, wherein one or more interior surfaces of the calibration assembly are coated with a light absorbing material.

Aspect 8. The method of any of Aspects 1 to 7, a first end of the fiber optic cable is coupled to a first portion of the calibration assembly and a second end of the fiber optic cable is coupled to a second portion of the calibration assembly, wherein a length of the fiber optic cable is above a threshold length, and wherein at least a portion of the fiber optic cable is at least partially curved, at least partially looped, at least partially bent, or at least partially coiled.

Aspect 9. The method of any of Aspects 1 to 8, wherein the one or more calibration values are configured to compensate for at least one of a phase delay associated with the one or more measurements, a time delay associated with the one or more measurements, pixel-to-pixel variations, and a temperature effect on the one or more measurements.

Aspect 10. A system comprising: a calibration assembly coupled to a time-of-flight (TOF) sensor system and further coupled to a fiber optic cable, wherein the TOF sensor system is configured to transmit a light signal through the calibration assembly and the fiber optic cable coupled to the calibration assembly; one or more diffusers on the calibration system, the one or more diffusers configured to receive the light signal from the fiber optic cable and diffuse the light signal as the light signal passes through the one or more diffusers; and one or more processors configured to: receive one or more measurements generated by the TOF sensor system based on the diffused light signal; and based on the one or more measurements, determine one or more calibration values configured to compensate for one or more errors in the one or more measurements.

Aspect 11. The system of Aspect 10, wherein diffusing the light signal comprises scattering the light signal to generate homogenized light with a homogeneous phase front, wherein the diffused light signal comprises the homogenized light with the homogeneous phase front.

Aspect 12. The system of any of Aspects 10 or 11, wherein a coupling between the calibration assembly and the TOF sensor system creates a seal between the calibration assembly and the TOF sensor system, wherein the seal contains the light signal within at least one of an optical path from the TOF sensor system to the calibration assembly and an enclosed space between the TOF sensor system and the calibration assembly, and wherein the seal prevents light from an external environment outside of the optical path or the enclosed space from entering the optical path or the enclosed space.

Aspect 13. The system of Aspect 12, wherein the calibration assembly is coupled to the TOF sensor system using one or more sealants applied at one or more interfacing locations between the TOF sensor system and the calibration assembly, wherein a first side of each sealant of the one or more sealants is placed in contact with a surface of the TOF sensor system and a second side of the sealant is placed in contact with a surface of the calibration assembly, wherein each of the one or more sealants comprises a light isolation material, and wherein the one or more sealants at the one or more interfacing locations between the TOF sensor system and the calibration assembly create at least part of the seal between the calibration assembly and the TOF sensor system.

Aspect 14. The system of any of Aspects 10 to 13, wherein a first end of the fiber optic cable is coupled to a first portion of the calibration assembly and a second end of the fiber optic cable is coupled to a second portion of the calibration assembly, wherein the first portion of the calibration assembly is coupled to a portion of the TOF sensor system that includes a first optical path from a light source of the TOF sensor system to the first portion of the calibration assembly, and wherein the second portion of the calibration assembly is coupled to a different portion of the TOF sensor system that includes a second optical path from the second portion of the calibration assembly to a TOF sensor chip of the TOF sensor system.

Aspect 15. The system of Aspect 14, wherein the first portion of the calibration assembly comprises at least one of an aperture limiter, a diffuser, a lens, and the first end of the fiber optic cable, and wherein the second portion of the calibration assembly comprises at least one of the second end of the fiber optic cable and the one or more diffusers.

Aspect 16. The system of any of Aspects 10 to 15, wherein one or more interior surfaces of the calibration assembly are coated with a light absorbing material.

Aspect 17. The system of any of Aspects 10 to 16, a first end of the fiber optic cable is coupled to a first portion of the calibration assembly and a second end of the fiber optic cable is coupled to a second portion of the calibration assembly, wherein a length of the fiber optic cable is above a threshold length, and wherein at least a portion of the fiber optic cable is at least partially curved, at least partially looped, at least partially bent, or at least partially coiled.

Aspect 18. The system of any of Aspects 10 to 17, wherein the one or more calibration values are configured to compensate for at least one of a phase delay associated with the one or more measurements, a time delay associated with the one or more measurements, pixel-to-pixel variations, and a temperature effect on the one or more measurements.

Aspect 19. The system of any of Aspects 10 to 18, further comprising the TOF sensor system.

Aspect 20. A non-transitory computer-readable medium having stored thereon instructions which, when executed by a sensor calibration system, cause the sensor calibration system to perform a method according to any of Aspects 1 to 9.

Aspect 21. A system comprising means for performing a method according to any of Aspects 1 to 9.

What is claimed is:

1. A method comprising:
sending, from a time-of-flight (TOF) sensor system coupled to a calibration assembly, a light signal to a fiber optic cable coupled to the calibration assembly;
receiving, by the calibration assembly, the light signal from the fiber optic cable;
diffusing the light signal via one or more diffusers on the calibration assembly;
generating, by the TOF sensor system, one or more measurements based on the diffused light signal; and
based on the one or more measurements, determining one or more calibration values configured to compensate for one or more errors in the one or more measurements.

2. The method of claim 1, wherein diffusing the light signal comprises scattering the light signal to generate homogenized light with a homogeneous phase front, wherein the diffused light signal comprises the homogenized light with the homogeneous phase front.

3. The method of claim 1, further comprising coupling the calibration assembly to the TOF sensor system, wherein the coupling is configured to create a seal between the calibration assembly and the TOF sensor system, wherein the seal contains the light signal within at least one of an optical path from the TOF sensor system to the calibration assembly and an enclosed space between the TOF sensor system and the calibration assembly, and wherein the seal prevents light from an external environment outside of the optical path or the enclosed space from entering the optical path or the enclosed space.

4. The method of claim 3, wherein coupling the calibration assembly to the TOF sensor system further comprises applying one or more sealants at one or more interfacing locations between the TOF sensor system and the calibration assembly, wherein a first side of each sealant of the one or more sealants is placed in contact with a surface of the TOF sensor system and a second side of the sealant is placed in contact with a surface of the calibration assembly, wherein each of the one or more sealants comprises a light isolation material, and wherein the one or more sealants at the one or more interfacing locations between the TOF sensor system and the calibration assembly create at least part of the seal between the calibration assembly and the TOF sensor system.

5. The method of claim 1, wherein a first end of the fiber optic cable is coupled to a first portion of the calibration assembly and a second end of the fiber optic cable is coupled to a second portion of the calibration assembly, wherein the first portion of the calibration assembly is coupled to a portion of the TOF sensor system that includes a first optical path from a light source of the TOF sensor system to the first portion of the calibration assembly, and wherein the second portion of the calibration assembly is coupled to a different portion of the TOF sensor system that includes a second optical path from the second portion of the calibration assembly to a TOF sensor chip of the TOF sensor system.

6. The method of claim 5, wherein the first portion of the calibration assembly comprises at least one of an aperture limiter, a diffuser, a lens, and the first end of the fiber optic cable, and wherein the second portion of the calibration assembly comprises at least one of the second end of the fiber optic cable and the one or more diffusers.

7. The method of claim 1, wherein one or more interior surfaces of the calibration assembly are coated with a light absorbing material.

8. The method of claim 1, a first end of the fiber optic cable is coupled to a first portion of the calibration assembly and a second end of the fiber optic cable is coupled to a second portion of the calibration assembly, wherein a length of the fiber optic cable is above a threshold length, and wherein at least a portion of the fiber optic cable is at least partially curved, at least partially looped, at least partially bent, or at least partially coiled.

9. The method of claim 1, wherein the one or more calibration values are configured to compensate for at least one of a phase delay associated with the one or more measurements, a time delay associated with the one or more measurements, pixel-to-pixel variations, and a temperature effect on the one or more measurements.

10. A system comprising:
a calibration assembly coupled to a time-of-flight (TOF) sensor system and further coupled to a fiber optic cable, wherein the TOF sensor system is configured to transmit a light signal through the calibration assembly and the fiber optic cable coupled to the calibration assembly;
one or more diffusers on the calibration system, the one or more diffusers configured to receive the light signal from the fiber optic cable and diffuse the light signal as the light signal passes through the one or more diffusers; and
one or more processors configured to:
receive one or more measurements generated by the TOF sensor system based on the diffused light signal; and
based on the one or more measurements, determine one or more calibration values configured to compensate for one or more errors in the one or more measurements.

11. The system of claim 10, wherein diffusing the light signal comprises scattering the light signal to generate homogenized light with a homogeneous phase front, wherein the diffused light signal comprises the homogenized light with the homogeneous phase front.

12. The system of claim 10, wherein a coupling between the calibration assembly and the TOF sensor system creates a seal between the calibration assembly and the TOF sensor system, wherein the seal contains the light signal within at least one of an optical path from the TOF sensor system to the calibration assembly and an enclosed space between the TOF sensor system and the calibration assembly, and wherein the seal prevents light from an external environment outside of the optical path or the enclosed space from entering the optical path or the enclosed space.

13. The system of claim 12, wherein the calibration assembly is coupled to the TOF sensor system using one or more sealants applied at one or more interfacing locations between the TOF sensor system and the calibration assembly, wherein a first side of each sealant of the one or more sealants is placed in contact with a surface of the TOF sensor system and a second side of the sealant is placed in contact with a surface of the calibration assembly, wherein each of the one or more sealants comprises a light isolation material, and wherein the one or more sealants at the one or more interfacing locations between the TOF sensor system and the calibration assembly create at least part of the seal between the calibration assembly and the TOF sensor system.

14. The system of claim 10, wherein a first end of the fiber optic cable is coupled to a first portion of the calibration assembly and a second end of the fiber optic cable is coupled to a second portion of the calibration assembly, wherein the first portion of the calibration assembly is coupled to a portion of the TOF sensor system that includes a first optical path from a light source of the TOF sensor system to the first portion of the calibration assembly, and wherein the second portion of the calibration assembly is coupled to a different portion of the TOF sensor system that includes a second optical path from the second portion of the calibration assembly to a TOF sensor chip of the TOF sensor system.

15. The system of claim 14, wherein the first portion of the calibration assembly comprises at least one of an aperture limiter, a diffuser, a lens, and the first end of the fiber optic cable, and wherein the second portion of the calibration assembly comprises at least one of the second end of the fiber optic cable and the one or more diffusers.

16. The system of claim 10, wherein one or more interior surfaces of the calibration assembly are coated with a light absorbing material.

17. The system of claim 10, a first end of the fiber optic cable is coupled to a first portion of the calibration assembly and a second end of the fiber optic cable is coupled to a second portion of the calibration assembly, wherein a length of the fiber optic cable is above a threshold length, and wherein at least a portion of the fiber optic cable is at least partially curved, at least partially looped, at least partially bent, or at least partially coiled.

18. The system of claim 10, wherein the one or more calibration values are configured to compensate for at least one of a phase delay associated with the one or more measurements, a time delay associated with the one or more measurements, pixel-to-pixel variations, and a temperature effect on the one or more measurements.

19. The system of claim 10, further comprising the TOF sensor system.

20. A non-transitory computer-readable medium having stored thereon instructions which, when executed by a sensor calibration system, cause the sensor calibration system to:
send, from a time-of-flight (TOF) sensor system coupled to a calibration assembly, a light signal to a fiber optic cable coupled to the calibration assembly;
receive, by the calibration assembly, the light signal from the fiber optic cable;
diffuse the light signal via one or more diffusers on the calibration assembly;
generate, by the TOF sensor system, one or more measurements based on the diffused light signal; and
based on the one or more measurements, determine one or more calibration values configured to compensate for one or more errors in the one or more measurements.
